(19) United States
(12) Patent Application Publication
(10) Pub. No.: US 2004/0093516 A1
(43) Pub. Date: May 13, 2004

(54) System for enabling secure remote switching, robotic operation and monitoring of multi-vendor equipment

(76) Inventors: Marc William Anthony Hornbeek, Camarillo, CA (US); Wayne Snyder, Simi Valley, CA (US); Athar Muzaffar, Thousand Oaks, CA (US); Larry Reitz, Moorepark, CA (US); Cleophus Price JR., Oxnard, CA (US); Donald Skanes, Simi Valley, CA (US); Paul Lupo, Newbury Park, CA (US); Robert Homkes, Camarillo, CA (US)

Correspondence Address: CROSBY, HEAFEY, ROACH & MAY, Suite 700, 1901 Avenue of the Stars, Los Angeles, CA, 90067, US

(21) Appl. No.: 10/293,190

(22) Filed: Nov. 12, 2002

(51) Int. Cl. H04L 9/00

(52) U.S. Cl. 713/201

(57) ABSTRACT

A system for enabling secure remote switching and robotic operation and monitoring of multi-vendor systems such as those in laboratories, factories, classes and networks. Equipment server nodes support Clients, TCL, and equipment server sub-systems. Clients use graphical user interfaces to log-in and access functions on server nodes. A client/server application-level protocol provides programmable levels of security and reliability. Server functions include user management, resource management, reservation, statisitical data, usage case storage and retrieval, and documentation of configurations. Electro-mechanical equipment server sub-systems interconnect a plurality of switch, action control, and command and display modules. Switch modules interconnect a plurality of multi-wire or fiber optical communication interfaces. Action control sub-system modules control power, servo, light, and other action pod modules. Power action modules control and measure equipment power. Servo action modules manipulate hand controls. Light action modules sense color states of lights. Mechanical attachment devices rigidly and precisely attach action modules to equipment that is robotically controlled.

### BACKGROUND OF THE INVENTION

This invention relates generally to the field of automated test equipment and more specifically to a machine, which enables secure remote switching and robotic operation, and monitoring of multi-vendor systems such as those in laboratories, factories, classes and networks.

Laboratories, factory system test facilities, classroom equipment facilities and network equipment facilities which use interconnected multi-vendor equipment share certain common requirements and limitations due to the need for people to handle equipment when it is used.

Traditionally it has been taken for granted that multi-vendor equipment laboratories (labs), which are required to test most products, need to be attended by system test, and product design people when they perform product or system-level tests and verification tasks. These laboratory environments, usually constructed with a variety of interesting, expensive technical equipment, are often considered “experimental” or “scientific” by casual observers. Such terms imply logical, ordered and efficient environments. In fact, the laboratory environments are frequently not logical or orderly at all. Many lab environments are remarkable for the inefficiency they cause the people that must use them over the course of entire careers.

Terms like “rats' nest” or “spaghetti” are commonly used by frequent laboratory users to describe typical messy laboratory equipment and environments.

The interconnection and manual operation of equipment is usually conducted by people selecting and plugging in patch cables directly to the multi-vendor equipment or via cable patching systems, usually of manual type, and manual operation and monitoring of hand controls such as switches and lights and power controls. These people are not always familiar with the exact laboratory environment at the time they need to use it because the environment is frequently subject to manual, typically undocumented, changes as different configurations are tested by different people. The interconnection cables, fiber optics and hand controls are subject to inherent, often excessive, and abusive manual handling and configuration instability. The interconnections, cables and connectors become unreliable and are a serious source of frustration and non-value-added effort. Furthermore, the type of cable required for any particular interconnection is dependent on the electrical or optical orientation of the systems that are to be interconnected. Frequently it is not apparent what electrical or optical orientation is required, and therefore, incorrect cable selection is an additional source of frustration and non-value-added effort (i.e., waste of time). Furthermore, the detection of incorrect cable selection or unreliable connections is not obvious from test results and may often require a fair amount of technical debugging skills and time to locate each faulty connection. Engineers (typically of the software type) who are not trained adequately for handling equipment that is sensitive to improper power sequencing, electrostatic handling procedures and cable interface standards, frequently cause premature failures of expensive laboratory equipment.

To make matters worse, laboratories are usually shared facilities because most organizations simply can not afford to allocate separate sets of multi-vendor test equipment to each user or group of users. It is not unusual for users to encounter schedule conflicts for individual pieces of equipment. Most laboratories do not have a scientific, on-line reservation system so the trial-and-error method of gathering the set of equipment needed for a particular test is a major source of frustration and non-value added time. This results in equipment-hoarding behaviors on the part of certain privileged users or groups, which in turn results in a low equipment utilization rate on hoarded equipment. Documentation of test results in a multi-vendor equipment environment is also a significant source of frustration and inefficiency. Without a common and automated user interface, people manually record the test conditions and results in notebooks or on scraps of computer paper. This most often leads to inaccurate or incomplete data. When a test case needs to be re-created for debugging and again for verification purposes, a significant amount of time is usually spent trying to re-create the original test environment or conditions.

All things considered, the typical inherent disorderly multi-vendor, shared laboratory environment can be shown to be less than 25% efficient for its users. In other words, the time spent by people “testing” is often only 25% of the total time spent dealing with the lab equipment. Equipment acquisition and cable set-up, configuration set-up and debug, re-creation of prior configurations and documenting results occupies 75% of the lab time for many people.

Laboratories provide facilities for both users (e.g., workstations for 25 people) and for equipment (e.g., racks). The needs of users and of equipment are not compatible, resulting in inefficient use of space and facilities. The mix of people and equipment in the same room also results in equipment problems because people tend to access the equipment directly without consistent discipline to arrange interconnections, invariably leading to the “rats' nest” problem. In addition, the presence of people in the laboratories introduces frequent contaminants and pollutants that affect the cleanliness and operation of the equipment. Attempts to address these issues have included locking people out of the laboratory and restricting access to designated people. This has met with limited success when there are many authorized people or if there are insufficient people to operate the equipment on behalf of others.

The requirement for equipment to be configured and operated manually by people results in relatively low utilization of that equipment and tradeoffs between people productivity and equipment utilization. This occurs partially because there is frequently insufficient people space to provide sufficient workers in the laboratories, but primarily, the laboratory equipment is not used during breaks in the work hours, and of course is rarely used after work hours. Users and equipment vendors have attempted to improve the utility of the equipment by making it multi-functional so that it will be used more often for a variety of tasks. Unfortunately this has lead to sharing problems mentioned earlier. Other attempts to improve the utilization of equipment is the use of automated test scripts which enable automated use of equipment when people are not present, but these have typically been limited to single-vendor configurations. The most important product level tests use multi-vendor test equipment and physical interconnections requiring physical configuration handling. Shift work tends not to work very well in professional organizations. Often policies intended to drive up the utilization of equipment during non-prime work hours have resulted in burnout of employees and reductions in overall productivity. Some global organizations that have employees in different time zones have tried to take advantage of the time zone differences and encourage workers to utilize equipment remotely during the non-prime down time of the remote laboratories. This has resulted in limited success because multi-vendor equipment configurations are not designed to be operated remotely. When a problem occurs at the remote laboratory or when configuration changes are needed, the users can not adequately access the equipment. This results In lost work time.

Certification laboratories are accredited by national (e.g., NIST, NPL, NSERC) or accredited industries or accredited manufacturers to test and qualify (certification) client manufacturers' new products or product variants for country-specific safety, emissions, homologation, and industry specific standards (e.g., UL, FCC, CSA, CE Mark, NEBS, etc.). These accredited certification laboratories have special equipment required for performing the prescribed tests called out by each standard. The manufacturing client sends “typical” examples of its product to the certification laboratory location, and usually provides specialist engineers from the client manufacturing company to participate in product testing, jointly with certification staff, who necessarily verify the certification process is correctly followed and results documented, but do not have the product specific knowledge. More often than not a product will not qualify during the first test due to a need for subtle design changes, and the product and staff must be scheduled for additional repeat visits until all the requirements are fulfilled. This is an expensive and time-consuming process, especially considering the travel, shipping and labor costs involved as well as significant test documentation costs, not to mention certification agency fees, which accumulate when additional testing is needed. Scheduling additional test sessions can be difficult when the certification laboratory resources are already scheduled. Serial scheduling may be needed if competing client companies and proprietary technologies are involved. These issues can result in significant and costly delays. Because some regulatory agencies have the legal authority to bar shipment, import or use of products that have not achieved certification, this process can be particularly costly in time-to-market and potential lost quarterly revenue and excessive competitive market penetration time.

Manufacturing companies more and more are outsourcing their product component and subsystem construction and hardware testing tasks to specialty contract manufacturers (CM) to take advantage of the CM's higher production volumes, lower components pricing, lower labor costs of certain markets and specialty equipment and expertise. These CMs have grown and are competing with each other aggressively, even though there is also significant co-operation between CMs to build products when needed to serve mutual customers. Many manufacturing companies have not been able to successfully out-source the final box-build and test phase of system (box) construction. While the CM has ample component level testing equipment and expertise, it does not usually have sufficient system level testing equipment and expertise for the final product of a typical customer. For example, a CM may have the equipment and expertise to build and test circuit boards that will be plugged into a telephone switch for a telephone switch manufacturer client, but the CM does not have the equipment or expertise to configure and test the entire telephone switch, which is necessary before it is sent to the end-customer of the client manufacturer.

There in lies a problem and an opportunity for both CMs and the client-manufacturing customer. Attempts to resolve this problem have resulted in a co-operation between the primary CM and the client. The CM will assemble the client manufacturer's box from the components, which were built by the CM or supplied by secondary CMs. The assembled box is then tested for limited functionality, packaged and sent to the client manufacturer for unpacking, final configuration, thorough functional testing, final packaging and shipment to the end customer. While this approach is an improvement compared to shipping unassembled components to the client, it obviously leaves plenty of room for improvement. The client must still handle the product, and, if there are problems with the hardware, then additional shipments back and forth with the CM are needed to replace failed components. An opportunity exist if the CM can at once reduce the amount of capital equipment needed for testing and also reduce the expertise needed for box-level testing. Then the entire box can be built and tested directly at the factory and shipped directly to the end customer without the intermediate step of shipping to the client. CMs that can accomplish this will be strategically advantaged, and have an opportunity for more revenue and profit, provided such a process can be done cost effectively. Client manufacturers would have the advantage of a quicker ship-to-order cycle, lower inventory costs, and much lower handling costs and could eliminate the costs of a special receiving, system test laboratory and shipping facility.

Classroom equipment facilities (i.e., “teaching labs”) that use multi-vendor equipment configurations as part of the instructional process are usually co-located with the class. This allows the instructor or class support staff or students to efficiently configure and repair equipment as required to suit the class instructional requirements. Commercial, public, private and enterprise organizations that offer such courses are limited to the number of students and equipment that can attend and be fitted into the available classroom environment. The explosive growth of distance learning applications over networks, especially the Internet, offers incredibly convenient individual learning and training business opportunities.

Unfortunately technology has limited the application of Internet based “distance learning” or “eLearning” to classes where hands-on equipment access is not required by the students. If a solution could be provided to enable students to remotely configure and operate the equipment then the scope of Internet based learning could be vastly expanded. Furthermore, if the equipment were available on-line, then learning opportunities would not be limited to normal work hours. 24/7 distance learning classes over the Internet would be feasible for such multi-vendor equipment based instruction.

Network equipment management has become especially important as more and more network operators are forced to improve their efficiencies from their substantial installed network build-outs while network service pricing is becoming more competitive in the deregulated world of today. Investigating and repairing arbitration problems when network-operating failures occur at the junction of separate network operator networks is particularly troublesome and expensive. Arbitration problems often require operators to deploy trucks with specialized equipment and highly skilled network technicians from each network operator to meet at the failure point, or points, to jointly troubleshoot the problem and determine which network equipment is responsible for the problem. Technology developed to minimize these problems include built-in loopback tests that can be controlled by network operator center staff to identify physical and logical level transmission and protocol problems with equipment or communication facilities. The built-in loop-back test systems work fairly well within a homogeneous network but are usually vendor specific, and do not operate beyond the boundary of each network. These are serious limitations when troubleshooting a multi-vendor, multi-network problem. The network management industry has concentrated on standards, which minimize the differences between technical management processes of networks. For example Simple Network Management Protocol (SNMP) and TELNET have emerged as dominant network management technologies for most packet based network elements. Standard Management Information Base (MIB) requirements has further brought significant commonality to management of individual network protocols. Despite these efforts, by standards organizations and enterprises that endeavor to support the standards, problems and inconsistencies persist, especially in multi-vendor network environments. Even single vendor network environments have significant problems when the network elements from the vendor were originally developed by different organizations, perhaps prior to acquisitions. Problems occur because of inconsistent implementations, or inconsistent application of the standards in live networks. Network elements often have their diagnostic features disabled whenever customer bandwidth is of concern because management information packets can utilize a significant bandwidth of the revenue generation channels, especially during testing. Out-of-band management communication schemes also occupy bandwidth and network resources, albeit designated channels so they have less potential to cause disruption of active channels, except when network elements must be taken out of service for testing. These approaches usually depend on a minimal level of functional network elements because the SNMP, TELNET and MIB functions are software based and depend on the same target processor as the network element under test. There is a significant opportunity for multi-vendor, and in some case single-vendor, network operators to save money if network management technology can be provided that is ubiquitous and non-intrusive.

The world-wide and outer space trend to replace synchronous and circuit switching based network technologies with asynchronous connectionless packet based Internet Protocol (IP) compliant technologies is driven by lower transmission costs of packet based facilities and the opportunity to piggyback on the world-wide development of convergent wireline and wireless open technologies and services for the internet-wide market-place. Internet telephony, using fast digital signaling processors (DSP) that implement elaborate compression schemes has proven effective when supported with adequate Quality of Service (QOS) packet routing schemes such as the MPLS standard. To further assure customers of the adequacy of these IP based services, network operators offer Service Level Agreements (SLA) which are legal contracts that define the minimally acceptable behavior of their service offerings. As a result distributed IP router technologies are expected to quickly replace centralized digital and analog telephone switches for local and long distance telephone and data services. Traditional telephone manufacturing giants are encountering serious competition from relatively new IP router companies. Unfortunately most routers that have been installed and designed are not as robust and not as well supported (by central telecom staff) as some of the traditional centralized telephone systems that people have come to expect. In many parts of the world not only is “dial-tone a God-given right” but also emergency services are legally mandated during disasters including utility power failures. Centralized telephone systems emphasized fault-tolerant hardware designs, centralized battery (DC) back-up power schemes, and centralized equipment management staff that ensured continuous service, even in the event of significant disasters. The goal of “no more than 4 hours down time in 40 years” established by the telephone industry is a significant challenge for IP router based networks. The newer distributed IP router schemes, although much less expensive to deploy than circuit based technologies, do not yet have the resiliency and support compared to older centralized telephone plant solutions. The higher operating costs can more than outweigh the low installation costs as has been observed with the short life of most competitive local exchange carriers (CLECs) in the USA. While the lower barrier to entry costs of IP router based approaches, coupled with deregulation support has enabled many new network operators to exist, the lack of resiliency of the IP packet equipment and services and unassurable SLAs are a developing liability to such businesses. This is a serious concern for network operators who are faced with fines and licensing issues, not to mention irate customers and lost revenue. The solutions usually applied for routers involve the installation of uninterrupted power supplies (UPS) to assure a router installed on or near customer points of presence continues to function during a power outage. These solutions do not take into account the fact that routers are complex software based machines with multiple failure modes. Even when the power is sustained, software problems can be triggered and the system may lock-up, typically just when communication is needed most for emergencies. The more advanced IP routers have more built-in redundancy and “hot-standby”, “hot-plug”, “resource-sparing”, “back-up” and “switch-over” functions to reduce the chance for any one failure causing an out-of-service network element. With these advanced features they are theoretically approaching the technical reliability of traditional telephone networks, but none have been in service long enough to prove their long-term reliability, and meanwhile the additional per-packet processing complexities of packet networks compared to circuit switching continue to evolve even as router based networks strive to meet SLAs and regulatory requirements. To reduce business liabilities IP packet based network operators need a more certain solution that none of the existing IP packet network technologies provide.

Optical technologies are popular with network operating companies because they can carry much higher bandwidths enabling higher volumes of tariffed services and more lucrative high-margin convergent voice/data/video services than copper or wireless technologies. Fiber optic communication systems support both synchronous digital and asynchronous packet services equally well. The very benefit offered, however, is the root of a serious operating problem. Any one fiber outage may affect thousands more customers and service revenue than a single outage with prior technologies. Optical technologies and service equipment have improved considerably in the ten years since their introduction, but so has the number of channels that may be “lighted”. The need for high availability and instant repair is more critical than ever. In fact, so much fiber has been deployed, while the bandwidth carrying capacity has been technologically increased by DWDM (dense wavelength division multiplexing), that supply currently far exceeds demand. Meanwhile, the cost of fiber optic test and management equipment is very high compared to more traditional instruments-as much as an order of magnitude per fiber compared to a copper cable these issues, coupled with the favored IP packet based equipment mentioned in the prior paragraph underscore that the business impact of a failure of any one fiber is more catastrophic compared to failures with prior technologies. Fiber optic based networks and mixed technology multi-vendor networks urgently require more effective network management solutions.

Solutions to address laboratory environment inefficiencies have taken many forms over the years, and some of these have had limited success but none have solved the general problems associated with multi-user, multi-vendor equipment labs described in the previous sections. Test equipment vendors have provided proprietary solutions to reduce test set-up and configuration problems for their specific products. These solutions take the form of programmable test scripts that allow a user to save files of commands and data that may be recalled whenever the specific device needs to be configured again but do not apply to the more general case of multi-vendor test configurations. Notable examples can found in U.S. Pat. No. 4,746,855 assigned to Teradyne and published papers by Robert Bombara of Teradyne, Inc. “Switch Matrix Simplifies Scope”, Electronic Design, April 1994; U.S. Pat. No. 4,736,374 assigned to Grumman Aerospace Corporation; U.S. Pat. Nos. 5,588,109; 5,953,684; 6,058,493; 6,163,805; 6,167,537 assigned to Hewlett Packard Inc.; U.S. Pat. No. 5,926,622 assigned to Lucent Technolgies, Inc.; U.S. Pat. No. 6,311,149 and published US Patent Application No. 2002/0055834 assigned to National Instruments, Inc.; and published papers Peleato et al. of Bell-Northern Research, “Automation of Regression Testing for Packet Switches”, Globecom '87, 1987, IEEE press and Hornbeek et al. of Bell-Northern Research, “Toolkit for ISDN Protocol and Network System Testing”, ECF, 1990, and “DPN Testing and Test Tool Application” Miscellany Vol. 4, BNR 1988.

Component and circuit level test equipment vendors have provided multi-instrument solutions but do not have general interfaces necessary for more general multi-vendor system level lab test environments. A notable example can be found in U.S. Pat. No. 4,736,374 assigned to Grumman Aerospace Corporation.

Laboratory use of switching systems in combination with specific automated test equipment has also been employed with significant success to reduce set-up time and improve automation in selected environments, but none of these applications use generic interfaces or cost-effective switching solutions to address the general multi-vendor test requirements described in previous sections. Notable examples are U.S. Pat. No. 4,630,224 assigned to the US Navy; U.S. Pat. No. 5,835, 565 assigned to Hammer Technologies; U.S. Pat. No. 5,862,052 assigned to Fisher-Rosemount Systems, Inc.; U.S. Pat. No. 5,862,052 assigned to Fisher-Rosemount Systems, Inc.; U.S. Pat. No. 6,157,185 assigned to Dit-Mco International;

U.S. Pat. No. 6,311,149 and published US Patent Application US 2002/0055834 assigned to National Instruments, Inc.; and published papers by Peleato et al. of Bell-Northern Research, “Automation of Regression Testing for Packet Switches”, Globecom '87,1987, IEEE press and Hornbeek et al. of Bell-Northern Research, “Toolkit for ISDN Protocol and Network System Testing”, ECF, 1990, and “DPN Testing and Test Tool Application” Miscellany Vol. 4, BNR 1988.

Test instruments designed to work in combination with robotic controls and sensors to manipulate hand controls, power and lights while switching, configuring and testing in a multi-user, multi-vendor lab environment have not been addressed in prior art. U.S. Pat. No. 6,212,566 assigned to IMEC, Leuven; U.S. Pat. No. 6,311,149 and published US Patent Application US 2002/0055834 assigned to National Instruments, Inc.; U.S. Pat. No. 6,366,217 assigned to Internet Telemetry Corp.; and a published paper by Endevco “Smart Transducers with Transducer Electronic Data Sheet (TEDS) automatically set their own parameters”, http://www.bksv.com/?Mival=bk view SHTML&ID=1621, 2000; address a mixture of sensors and control of electronic instruments in a single user environment for component level testing, but do not address the multi-user needs of communication product level test equipment.

Multi-user, multi-vendor laboratory access and scheduling complexities in combination with the required ability to actually execute switching and robotic control necessary for multi-vendor equipment testing is not addressed in prior art. Published Patent Application US 2002/0032762 by Price et al. does describe a laboratory equipment configuration and scheduling software approach, but the reference does not provide sufficient detail to understand the implementation and also does not describe in any detail the hardware required to switch multi-vendor equipment, or provide any approach to operate hand controls, or sensors. The reference does describe the use of commercial power control, in combination with the configuration system, but does not provide sufficient detail to understand how this would be done economically or efficiently as an integral part of the overall system design in a multi-vendor laboratory.

Graphical client/central server architectures to enable remote test access to test instruments have been defined in prior art but use standards based application layer IP packet based protocols, which are inherently open to reliability and security problems. Furthermore, the representations on the graphical client applications are limited to a replication of a specific instrument environment and do not address the general problem of multi-user, multi-vendor equipment environments. Notable examples are found in U.S. Pat. No. 5,588,109 assigned to Hewlett Packard, Inc.; U.S. Pat. No. 5,781,720 assigned to Segue Software, Inc.; U.S. Pat. No. 6,311,149 and published US Patent Application US 2002/0055834 assigned to National Instruments, Inc.; published US Patent Application US 2001/0047213 by Sepe, Jr.; published US Patent Application US 2002/0032762 by Price et al.; publications by Carnegie Mellon University “Carnegie Mellon's Virtual Lab: Application for the Smithsonian Computerworld Leadership Award” http://www.ece.cmu.edu/stancil/virtuallab/application.html 1995; and publication by Knight et al “A Distance Learning Laboratory for Engineering Education”, Georgia Institute of Technology 1997

No prior art addresses the specific switching component level needs for a multi-user, multi-vendor laboratory. There is prior art for analog and digital cross-connect systems used in conjunction with selected test environments, but these do not describe specific component level features that are needed to make them suitable for the application, and economical and functional for the multi-user, multi-vendor laboratory environments. Notable examples are U.S. Pat. No. 4,088,845 assigned to Societe Lannionnaise d'Electronique (SLE); U.S. Pat. No. 4,300,207 assigned to Grumman Aerospace; U.S. Pat. No. 4,630,224 assigned to the US Navy; U.S. Pat. No. 4,746,855 assigned to Teradyne, Inc.; U.S. Pat. Nos. 5,365,511 and 5,383,183 assigned to NEC Corporation; U.S. Pat. No. 5,644,115 assigned to Keithley Instruments, Inc.; U.S. Pat. No. 5,835,565 assigned to Hammer Technologies, Inc., U.S. Pat. No. 6,005,696 assigned to Bell Atlantic Network Services, Inc.; U.S. Pat. No. 6,157,185 assigned to Dit Mco International; U.S. Pat. No. 6,311,149 and published US Patent Application US 2002/0055834 assigned to National Instruments Corporation; published US Patent Application US 2001/0024906 by Salmans et al.; Patent WO 00/76224 by ADC Telecommunications; a published paper Peleato et al. of Bell-Northern Research, “Automation of Regression Testing for Packet Switches”, Globecom '87, 1987, IEEE press; a published paper Les Bohn “Digital Cross Connect keeps networks honest”, Telephone Engineer & Management, Nov. 15, 1986, M/A Corn Telecommunications; a published paper Robert Bombara of Teradyne, Inc. “Switch Matrix Simplifies Scope”, Electronic Design, April 1994; a published paper by Knight et al, “A Distance Learning Laboratory for Engineering Education”, Georgia Institute of Technology 1997; and a published paper by Panessidi of NHC, “Go for Automatic Latest Physical-layer-management products eliminate manual intervention”, Communications News, October 1999.

No prior art references address the specific requirements of Contract Manufacture box-level testing. Prior art does exist for component level testing but not box-level testing issues discussed above. Notable examples include U.S. Pat. No. 4,736,374 assigned to Grumman Aerospace Corporation; U.S. Pat. No. 4,746,855 assigned to Teradyne, Inc. and a published paper by Bombara, Robert Teradyne, Inc., “Switch Matrix Simplifies Scope”, Electronic Design April 1994.

No prior art references address the specific needs of multi-user, multi-vendor classroom equipment requirements. There is prior art dealing with distance learning for individual instruments in a non-shared environment, but the methods presented are not scalable to multiple simultaneous users and multi-vendor equipment access, reservation, switching and operation.

Notable examples include U.S. Pat. Nos. 6,170,014 and 6,282,573 assigned to Community Learning and Information Network; a published paper by Carnegie Mellon University “Carnegie Mellon's Virtual Lab:

Application for the Smithsonian Computerworld Leadership Award” http://www.ece.cmu.edu/stancil/virtual-lab/application.html 1995; and

publication by Knight et al “A Distance Learning Laboratory for Engineering Education”, Georgia Institute of Technology 1997; a published paper by Myers et al., “Collaboratories: Bringing National Laboratories Into The Undergraduate Classroom and Laboratory Via The Internet”, Council on Undergraduate Research Quarterly, March 1997; and a published paper by National Instruments, “Distance Learning Remote Laboratories using LabVIEW”, http://zone.ni.com/devzone, 2002.

No prior art references demonstrate technology to resolve the previously discussed specific issues which network operators have for multi-vendor network arbitration, IP packet technologies or Optical networks. There is prior art discussing single vendor or single network testing methods, individual packet (but not IP test technologies) and testing of individual fiber system testing. Notable examples include U.S. Pat. No. 4,545,013 assigned to Infinet, Inc.; U.S. Pat. No. 5,060,226 assigned to Phoenix Microsystems, Inc.; U.S. Pat. No. 5,835,565 assigned to Hammer Technologies, Inc.; U.S. Pat. Nos. 5,854,889 and 6,425,096 assigned to MCI WorldCom, Inc.; U.S. Pat. No. 6,005,696 assigned to Bell Atlantic Network Services, Inc.; U.S. Pat. No. 6,381,604 assigned to Cisco Technology, Inc.; Patent WO 00/767,224 by ADC Telecommunications; Patent EP 1 229 745 by NHC Communications, Inc.; a published paper Hornbeek et al., “A Network Test Environment for Packet Switching Networks”, 1983 International Electrical and Electronics Conference Proceedings, IEEE 1993; a published paper by Heiminan, Kopf, “Network Design, Testing Tools Now Portray the Big Picture”, America's Network, 1996; a published paper by Kuzyszn et al., “ISDN Protocol and Service Verification and Performance Testing”, CH2424-0/87/0000-1356, 1987, IEEE; a published paper by Lenny Leibmann, “Rethinking Remote Management”, Network Magazine.com, July 2002; and a published paper by Simonson, “All Systems go: Remote testing capability is reducing Intermedia Communications' frame relay service costs and improving customer satisfaction”, Telephony Magazine, November 1997. In summary there are many deficiencies in the prior technology relative to meeting the needs of multi-user, multi-vendor equipment needs for laboratories, manufacturing, classrooms and networks. Notable deficiencies noted in earlier paragraphs include the following highlighted items:

a) Test equipment script languages supported on test systems are limited to individual instruments;

b) Lab equipment interfaces supported are too limited;

c) Switching system technologies applied in labs are not purpose-built and are not economical for wired or optical interconnections;

d) Robotic hand controls, sensors and power controls necessary for remote operation are not integrated into the systems;

e) Graphical client/central server systems have not adequately considered security and reliability issues as well as integration with multi-vendor physical equipment environments;

f) Suitable economical switching components have not been defined;

g) Box-level testing solutions for contract manufacturers have not been defined;

h) Classroom technology suitable for multi-vendor, multi-user requirements have not been defined;

i) Specific and adequate technologies to directly address for multi-vendor network elements, multi-network arbitration needs, as well as IP packet based technologies and Optical network technologies have not been defined.

### BRIEF SUMMARY OF THE INVENTION

A primary object of the invention is to provide a means for multiple clients to remotely access an equipment server node using a secure, reliable application level communications protocol.

Another object of the invention is to provide both a graphical user interface as well as an equipment control language interface such as Tcl (tool control language) to control and monitor the equipment server node.

Another object of the invention is to provide a means for users to reserve shared equipment and physical interconnections.

A further object of the invention is to provide a means for multiple clients to remotely configure test equipment and multiple communication systems.

Yet another object of the invention is to provide a means for multiple clients to operate and monitor multi-vendor systems using robotic controls and sensors.

Still yet another object of the invention is to provide a means to store and recall and automatically implement multi-vendor equipment configurations and interconnections of network cables and fibers.

Another object of the invention is to provide automated documentation of multi-vendor equipment configurations and test results.

Another object of the invention is to provide an automated means for system test setup.

A further object of the invention is to reduce the non-value added time and effort of setting up laboratory equipment prior to performing a test.

Yet another object of the invention is to provide a system test environment that does not require expert assistance to use.

Still yet another object of the invention is to provide a means to reduce equipment hoarding by users that require dedicated and reliable equipment configurations.

Another object of the invention is to reduce the inefficiency of product testing environments.

Another object of the invention is to provide a more economical approach utilizing less equipment for testing multi versions and test suites of a product.

A further object of the invention is to provide statistical equipment monitoring and managed control of equipment for laboratories, factories, courses and networks.

Yet another object of the invention is to provide an automated regression testing facility for testing manual features of products such as lights, power and hand controls.

Still another object of the invention is to provide a larger number of users access to equipment than would be possible if the users had to be physically present.

Another object of the invention is to provide efficient, affordable and traceable system box-level testing for factories enabling test equipment sharing and automated scripting in place of subject matter experts.

Another object of the invention is to provide the ability to reduce the number of test laboratories needed by an organization.

A further object of the invention is to provide 24/7 access to laboratories and equipment environments in factories and networks.

Yet another object of the invention is to provide more efficient clean-room laboratories which can be configured without desks, chairs, workstations and manual equipment.

Still another object of the invention is to allow consultants and others to test their software or hardware products remotely without visiting a laboratory.

Another object of the invention is to provide information technology specialists the ability to remotely monitor and control the equipment they manage.

Another object of the invention is to provide remote multi-vendor network management arbitration functions.

A further object of the invention is to provide automated physical layer network management control.

Yet another object of the invention is to enable new business models for lab-hosting services.

Still another object of the invention is to enable automated remote equipment certification services and expanded 24/7 test service businesses.

Another object of the invention is to enable new remote information technology business services.

Another object of the invention is to enable new remote distance learning business services for courses that require hands-on equipment training and facilitate 24/7 service.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a system which enables secure remote switching and robotic operation and monitoring of multi-vendor systems in laboratories, factories, classes and networks comprising: a server node software application, which executes on one or more server computers and supports multiple simultaneous clients and attached equipment server resources, a plurality of client software applications executing on a plurality of workstation software and hardware machine environments, providing a plurality of users with graphical user interfaces means as well as automated TCL means to log-in and access functions on server nodes, wherein a client/server application level protocol provides programmable levels of security and reliability for application data sent between a plurality of server nodes and plurality of remote client application machines. A plurality of distributed client/server software functions provide functions including user identification, security, privileges, resource installation, resource reservation, resource activation, statistical analysis of users and resources, user-to-user messaging, system debugging usage case storage and retrieval, and resource management and documentation of equipment configurations. A plurality of communication circuits types and protocol types facilitate any number of networked communication methods between a plurality of remote clients and a plurality of server nodes and a plurality of equipment server nodes, each with at least one computer connected to a plurality of electromechanical subsystems. Each electromechanical sub-system has a plurality of interconnect circuits that interconnect a plurality of server modules, action control modules, switch modules, and command and display modules. A plurality of switch sub-system modules interconnect a plurality of multi-wire communication circuit interfaces or fiber optical circuit interfaces while a plurality of action control sub-system modules connect to, and control, by wire or wireless means a plurality of power action modules, servo action modules, light action modules and other action pod modules. A plurality of command and display sub-system modules interconnect the server module sub-system to a plurality of user-machine interfaces of equipment; a plurality of power action modules control power for equipment and a plurality of power source types and measure voltage and current. A plurality of servo action modules manipulate a plurality of types of hand controls and a plurality of light action modules sense a plurality of color and intensities of lights while a plurality of mechanical attachment devices rigidly and precisely attach a plurality of action modules to equipment which is thus robotically controlled.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a schematic block diagram of the invention.

FIG. 2 is a schematic block diagram of a server node sub-systems of the present invention.

FIG. 3 is a schematic block diagram of the server node sub-system controller and interconnect back plane.

FIG. 4 is a schematic block diagram of an action module sub-system of the present invention.

FIG. 5 is a schematic block diagram of a power action module of the present invention.

FIG. 6 is a schematic block diagram of a servo action module of the present invention.

FIG. 7 is a schematic block diagram of a light action module of the present invention.

FIG. 8 is a perspective view of a preferred embodiment of the present invention.

FIG. 9 is a schematic block diagram of a quad-4 copper switch device of the present invention.

FIG. 10 is a schematic block diagram of a command and display sub-system of the present invention.

FIG. 11 is a schematic diagram of possible interconnections between quad-4 switch devices.

FIG. 12 is a schematic diagram of overall interconnection in a system of the present invention.

FIG. 13 is a schematic diagram of an optical switch device of the present invention.

FIG. 14 is a perspective view of a preferred embodiment of the preferred embodiment of the optical switch device.

FIG. 15 is a schematic diagram of another embodiment of the optical switch device.

FIG. 16 is a partial flow chart of the operations of the client software of the present invention.

FIG. 17 is a continuation of the flow chart of the operations of the client software of FIG. 16.

FIG. 18 is a flow chart of the operations of the client/server communications protocol of the present invention.

FIG. 19 is a flow chart of the operations of the server software of the present invention.

FIG. 20 is an exploded view of the server resources graphical user interface.

FIG. 21 is a view of the hardware installation wizard graphical user interface of the present invention.

FIG. 22 is a view of the device definition graphical user interface of the present invention.

FIG. 23 is a view of the device interfaces graphical user interface of the present invention.

FIG. 24 is a view of the device profile graphical user interface of the present invention.

FIG. 25 is a view of the resource available graphical user interface of the present invention.

FIG. 26 is a view of the installation assistant graphical user interface of the present invention.

FIG. 27 is a view of the server configuration graphical user interface of the present invention.

FIG. 28 is a view of the active clients graphical user interface of the present invention.

FIG. 29 is a view of the hardware communicator graphical user interface of the present invention.

FIG. 30 is a view of the server connection properties graphical user interface of the present invention.

FIG. 31 is a view of the server users graphical user interface of the present invention.

FIG. 32 is a view of the “modify” users graphical user interface of the present invention.

FIG. 33 is a view of the server group privileges graphical user interface of the present invention.

FIG. 34 is a view of the server domains graphical user interface of the present invention.

FIG. 35 is a view of the server statistics graphical user interface of the present invention.

FIG. 36 is a view of the client user log-on graphical user interface of the present invention.

FIG. 37 is a view of the client server tab graphical user interface of the present invention.

FIG. 38 is a view of the client usage case open graphical user interface of the present invention.

FIG. 39 is a view of the client usage case selection graphical user interface of the present invention.

FIG. 40 is a view of the client connections graphical user interface of the present invention.

FIG. 41 is a view of the client end-points graphical user interface of the present invention.

FIG. 42 is a view of the client reservation graphical user interface of the present invention.

FIG. 43 is a view of the client user messaging graphical user interface of the present invention.

FIG. 44 is a view of the client action pod graphical user interface of the present invention.

FIG. 45 is a schematic block diagram of a remote lab applications of the present invention.

FIG. 46 is a schematic block diagram of an automated system test applications of the present invention.

FIG. 47 is a schematic block diagram of a disaster recovery applications of the present invention.

FIG. 48 is a schematic block diagram of a physical layer switched network application of the present invention.

FIG. 49 is a schematic block diagram of an inter-network arbiter applications of the present invention.

FIG. 50 is a view of the client connections graphical user interface of the present invention when used to perform the first remote laboratory application.

### DETAILED DESCRIPTION OF THE PREFERRED EMBODIMENTS

Detailed descriptions of the preferred embodiment are provided herein.

It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

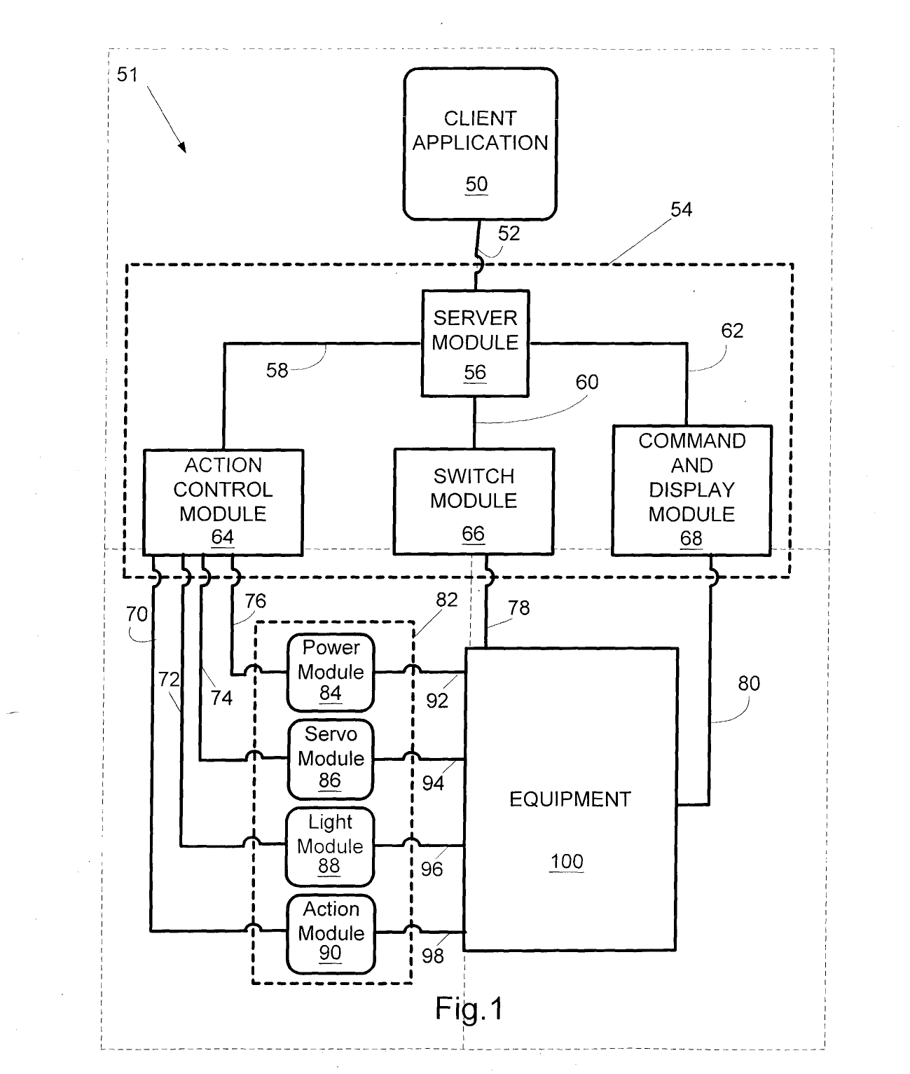

FIG. 1: Schematic Block Diagram of the Invention FIG. 1 illustrates a system 51 according to the current invention which enables secure remote switching and robotic operation of multi-vendor equipment systems 100 in laboratories factories, classes, and network interchanges. The multi-vendor equipment 100 may be made up from any number of equipment makes from any number of vendors. A user of the system 51, of which there may be multiple simultaneously using one or more independent or interconnected systems 51, is provided with client application software 50 that may be loaded and operated on a host computer of the users' choosing. The host computer may be any of a wide variety of types such as, but not limited to, a personal computer, laptop, workstation, mini-computer, mainframe or embedded processor or other computer capable of processing C language or JAVA application software. The host computer may be operating under a wide variety of software operating systems such as, but not limited to, Windows®, UNIX®, and Linux® or other operating system capable of supporting C language or JAVA® software applications⁰. It will be appreciated that the above characteristics belong to an embodiment of the inventive system 51 but any type of computer, computer language and computer operating system can be used to implement the invention. ⁰ Windows® is a registered trademark of Microsoft Corporation.

The software operation of a preferred embodiment of this client software is described in later sections. The client application software 50 communicates with a server node system 54 by way of a server module 56 and a communication protocol 52. By means of this communication, the client application is able to exchange a variety of encoded messages with the server node. A preferred embodiment of the communication protocol 52 is a peer-to-peer application protocol that is implemented within the client application 50 and the server module 56. A preferred embodiment of protocol 52 operates at the application level of the Open Systems Interconnection (OSI) “model” protocol stack layer architecture as defined by the International Standards Organization (ISO). Because the protocol is operating at the application level, it may be encapsulated and transported by a number of lower layer protocol stacks such as, but not limited to, TCP/IP, Ethernet, ATM, 802.11, frame relay, Signaling System #7, TCAP (transaction capability action part), IEEE 488, SCADA (supervisory control and data acquisition), CEBus, GPIB (general purpose interface bus), IEEE 1415, and other point-to-point, multi-point, broadcast, connection-oriented or connectionless protocols which provide the ability to transport application specific data between addressable peer points of presence. Furthermore, the communication protocol 52 may be carried on any number of networks that are based on one or more network technologies such as, but not limited to, copper, wired, fixed wireless, mobile wireless, Internet, Internet2, Intranet, connection-oriented, connection-less, digital, analog, satellite, optical, multiplexed, point-to-point, virtual, dedicated, enterprise, public or other networks that provide interconnection between addressable end-points.

Although, the client application software 50 and communication protocol 52 are implemented using a client-server architecture in this preferred embodiment, it will be apparent to those skilled in the art that the system may also be implemented using proxy and also autonomous agent architectures. Besides providing protocol termination functions described in the previous paragraphs, the server module 56 performs system management functions and central controller functions for the server node system 54. The server module controls the distribution and routing of messages to and from other modules within the server node system, and takes prescribed actions on specific messages that are destined for the server node module. The server module 56 directly communicates with at least three other types of modules within the server node system 54, namely an action control module 64, a switch module 66 and a command and display module 68. Any of the communication paths between each of these modules, namely 58, 60 and 62 may be implemented by a number of technologies such as, but not limited to, LVDS (low voltage differential signals), Ethernet, Firewire, USB, TDM, CEBus, copper interconnects, frame relay, optical or wireless. The action control module 64, of which there may be a plurality in the server node system, implements robotic control and monitoring functions for controlling a plurality of input sensors and output control devices such as, but not limited to, power modules 84, servo modules 86, light modules 88, and other action modules 90. Any of the interconnections between the action control module and the action modules, namely 70, 72, 74, and 76 may be implemented using a number of bus, LAN or WAN protocol technologies such as, but not limited to, TCP/IP, ATM, 802.11, frame relay, Ethernet, IEEE 488, USB SCADA, CEBus, GPIB, IEEE 1415, and other technologies that have the ability to transport encoded messages in both directions either full-duplex or not, bit-oriented or not.

An action module positioner 82 is a mechanical assembly that attaches action modules to equipment 100. The power module 84 controls the electrical power required by the equipment 100. The power module 84 may support a number of AC or DC electrical power sources, which are supplied to the equipment by way of connections 92. Connections 92 may be implemented with a number of technologies such as, but not limited to, wires, relays, bus bars, circuit board tracks, flex circuits, semi-conductors, microwave systems, mechanical means, electromechanical means, electromagnetic means, generators, batteries, transmission lines, transformers, and optical coupled devices.

The servo module 86 provides means to operate hand controls of the equipment 100 by way of a plurality of interfaces illustrated as 94. Hand controls include, but are not limited to, toggle switches, slide switches, rotary controls, push-buttons, levers, touch sensitive switches, proximity switches, pressure switches and other controls that are operated by a human hand or mechanical means. The servo action module 86 includes functions that supply motive force and mechanical apparatus that together robotically simulate one or more prescribed actions of the hand pertaining to the particular hand control or other mechanical means, in response to a command from the action control module 82 or sensed equipment behaviors. The motive force of the servo module 86 may be implemented with a number of technologies such as, but not limited to, AC or DC powered electromagnetic devices, relays, servo units, stepper motors, linear motors, solenoids, and other devices that have the ability to translate signals provided by interconnection 74 into motion needed by interface 94 and may also have the ability to provide feedback and control information from interface 94 to interconnection 74.

The light module 88 provides light sensing capabilities, which may include color and intensity discrimination functions, to sense the status of lights which are embedded indicators of equipment 100 at a plurality of interface points 96. Light sources may include, but are not limited to LEDs, incandescent light bulbs, infrared, laser light, fluorescent light sources, and any light source in the visible spectrum. It includes the detection of the absence of light (dark or light-off condition) or a light source, even in the presence of ambient light. The light module 88 may be implemented with a number of technologies such as, but not limited to, photodiodes, photoresistors, phototransistors, CCD cameras, photocells, photomultipliers and other sensors that have the ability to sense light on interface 96 and translate it into signals that may be transmitted on the interface 72. Besides the power module 84, servo module 86 and light module 88 described previously, it will be apparent to those of ordinary skill in the art that a number of other types of action modules 90 may be used within the scope of the present invention such as, but not limited to, video cameras, telephone dialers, telephone paging systems, telephone answering machines, personal messaging systems, circuit relays, optical sensors, light sources, temperature sensors, temperature controllers, pressure sensors, pressure controllers, vibration sensors, vibration controller, light controllers, auditory sensors, speakers, listening devices, radio receivers, radio transmitters, motion sensors, electrical measurement devices, power measurement devices, chemical sensors, chemical delivery systems, sensors which detect and/or discriminate smells, organic sensors, human sensory detection systems, human motion emulation systems and others that have the ability to communicate with equipment through the interface 98 and translate the communication into signals that may be transmitted on the interconnection 70 or translate commands from the interface 70 into actions on the interface 98. Switch module 66, of which there may be a plurality in a server node system, implements switching functions that interconnect two or more equipment interfaces 78 to each other, according to commands received on interface 60.

The switch module 66 functions may include, but are not limited to, point-to-point, and point-to-multi-point physical layer switching, multi-wire interface switching (including, but not limited to RS232, V.21, V.21bis, V.35, telephone wires, FXS, FXO, xDSL, T1, E1, T3, E3, 10BT, 100BT, Gigabit Ethernet, Firewire, USB, and coaxial cable), fiber optic interface switching (including but not limited to single mode, multi-mode, DWDM, OC3, OC12, OC48, OC192, Sonet, ATM), and wireless interface switching (including but not limited to those associated with wireless technologies of Blue Tooth, CEB, SCADA, 802.11b, TDMA, CDMA, GSM, IR and microwave.)

The command and display module 68, of which there may be a plurality in a server node system, implements a plurality of multiplexing and connection functions for a plurality of user interfaces 80 of the equipment 100 to enable the user interface commands and responses to be transported between the server module interface 62 and the equipment interface 80. Technologies supported by the command and display module may include, but are not limited to, RS232 character mode, RS232 Telnet, V.24/V.21, V.24/V.21bis, SNMP, FTP, Ethernet 10Bt or 100Bt or Gigabit Ethernet, wireless interfaces and any other interface protocol that may be attached directly or indirectly to the equipment to carry user commands to the equipment and replies from the equipment to the user.

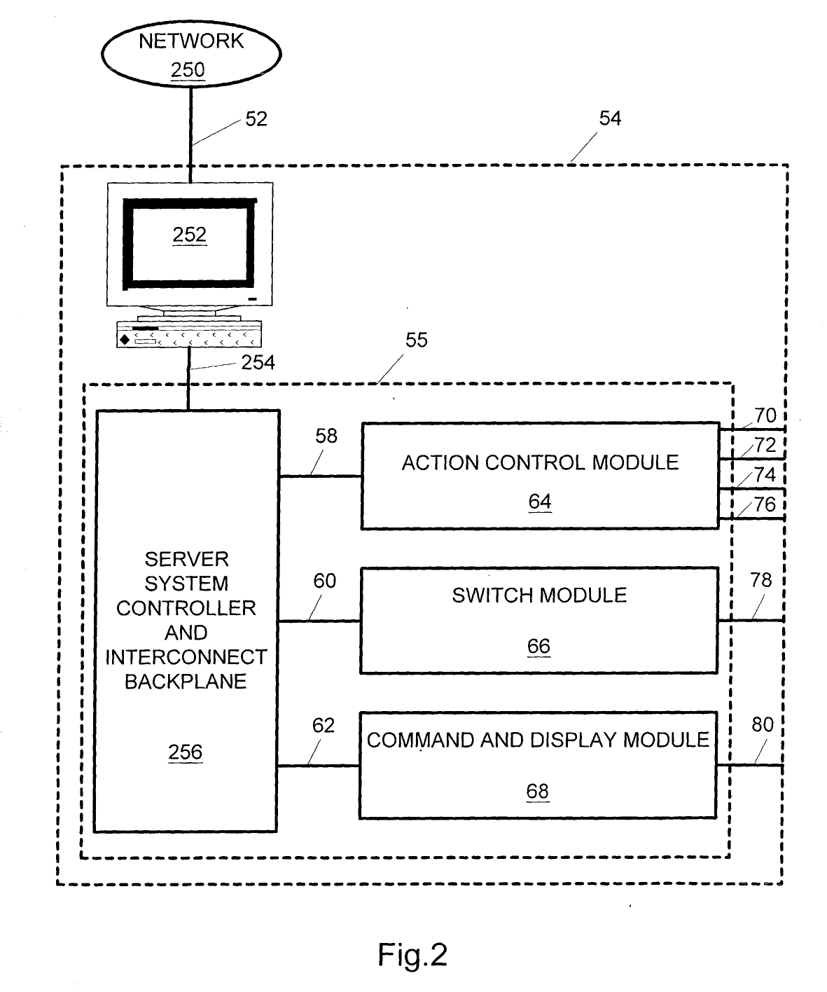

FIG. 2: Sub-system Composition of Server Node FIG. 2 illustrates the sub-system composition of the server node system 54. The server node application software 252 is loaded and executed on a host computer of the users' choosing. The host computer may be any of a wide variety of types such as, but not limited to, rack-mount server, fault-tolerant rack-mount server, floor-mount computer models, a personal computer, laptop, workstation, mini-computer, mainframe or embedded processor or other computer capable of processing C language or JAVA application software.⁰ The host computer may be controlled by a wide variety of software operating systems such as, but not limited to, Windows®, UNIX®, and Linux® or other operating system capable of supporting C language or JAVA® software applications⁰. The software features and operation of this server software is described in following descriptions of the present invention. Operational object code for a Windows® version of the server software is provided in the CD referenced in the appendix. ⁰ C is a registered trademark of Bell Laboratories. JAVA is a registered trademark of Sun Microsystems ⁰ Windows® is a registered trademark of Microsoft Corporation.

The server application software 252 communicates with a plurality of remote client applications 50 (see FIG. 1) by means of a network 250 and the previously described communication protocol 52. The server node application software 252 is connected to a plurality of server node subsystems 55 by means of an inter-node interconnect subsystem 254. Each server node subsystem 55 includes a system controller and interconnect back-plane unit. The inter-node interconnect subsystem 254 may be implemented using a number of communication technologies, including, but not limited to, TCP/IP, Ethernet, ATM, 802.11, frame relay, Signaling System #7, TCAP, IEEE 488, SCADA, CEB, GPIB, IEEE 1415, and other point-to-point, multi-point, broadcast, connection-oriented or connectionless protocols that provide the ability to transport application specific data between peer points of presence and copper, wired, fixed wireless, mobile wireless, Internet, Internet2, Intranet, connection-oriented, connection-less, digital, analog, satellite, optical, multiplexed, point-to-point, virtual, dedicated, enterprise, public or interconnect technologies that provide interconnection between addressable end-points.

One important distinguishing feature of the preferred embodiment of the present invention is that the communications protocol 52 is relayed through the server node application software 252 to each server node subsystem 55. This ensures each transaction does not suffer delays, which might otherwise be caused by the server node application software 252 and also ensures that the power of the host computer for the server node application software 252 is not wasted with unnecessary processing. This also allows the host computer for the server node application software 252 to be relatively low cost compared to what would be needed otherwise. It also enables the size of the sever node (number of server node subsystem units 55) to be scalable according to the power of the host computer. The server node subsystem 55 may be implemented with a variety of technologies and formats such as, but not limited to, a rack-mounted card cage, integrated power supply, integrated cooling unit, a back-plane, a plug-in server system controller and interconnect back plane 256 and with a plurality of plug-in sub-system action control modules 64, switch modules 66 and command and display modules 68.

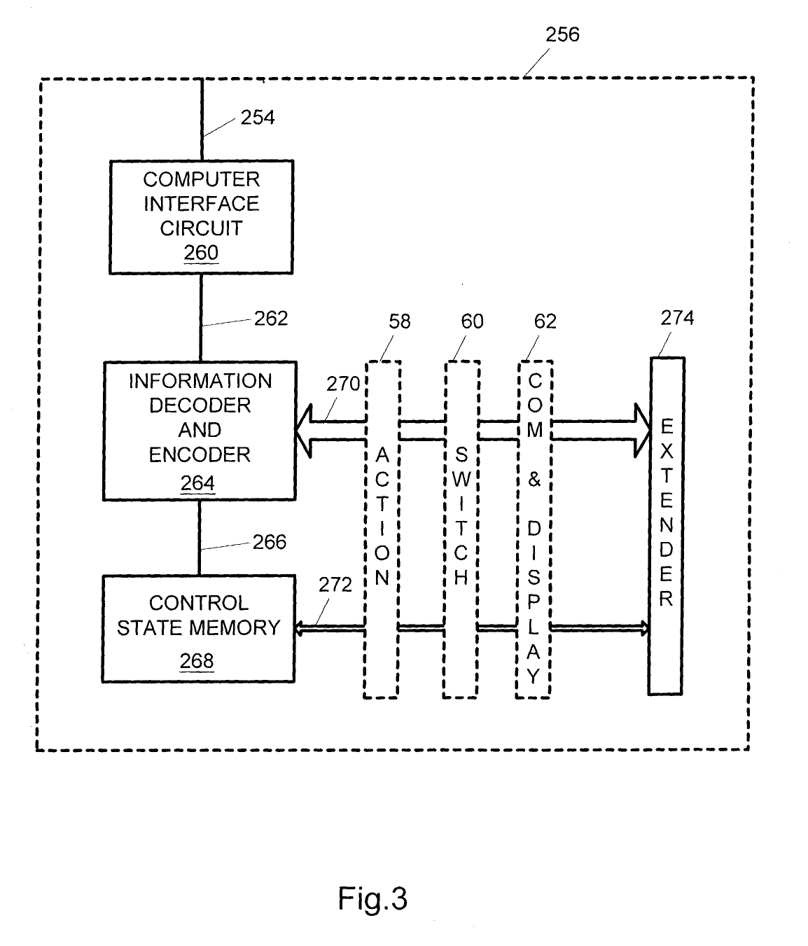

FIG. 3: Server Node Sub-system Controller and Interconnect Back-plane.

FIG. 3 illustrates the preferred embodiment of the server node subsystem controller and interconnect back-plane. A computer interface circuit 260 provides standard communication control functions between the inter-node interconnect system 254 and the protocol information decoder and encoder 264. The interface circuit design is selected according the protocol chosen for the inter-node interconnect system 254.

For example, if the protocol used by 254 is Ethernet then it includes an Ethernet PHY and framer chip as those of ordinary skill in the art can easily design. The information decoder and encoder processes protocol information from the communications protocol 52, which is relayed through the computer interface circuit 260 via the interconnection between computer interface circuit and information decoder and encoder 262. The interconnection between computer interface circuit and information decoder and encoder 262 may be a semi-conductor, or electrical path or bus or any hardware synchronous or asynchronous communication technologies provided the speed of communication is matched to the aggregate bandwidth requirements of a plurality of I_bus channels 270 and system control channels 266. The I_bus channel 270 may be a semi-conductor, or electrical path or bus or any hardware synchronous or asynchronous communication technologies provided the speed of communication is matched to the aggregate bandwidth requirements of a plurality of server module to action control module communication paths 58, 60, 62 and a bus extender 274. The processor used in the protocol information decoder and encoder 264 may be a micro-processor, digital signal processor, custom integrated circuit, or programmable circuit such as an FPGA (field programmable gate array). The result of processing information from the interconnection between computer interface circuit and information decoder and encoder 262 will direct information and sub-system commands to channels of the I-bus channel 270 or system control 266. A control state memory 268 receives information from 264 via interconnect channel 266.

The system control channel 266 may be a semi-conductor, or electrical path or bus or any hardware synchronous or asynchronous communication technologies provided the speed of communication is matched to the aggregate bandwidth requirements of a plurality of system control channels 266. The control state memory 268 stores a local copy of current state information for the server node sub-system and drives message C_bus channel 272 to control the states of other server node sub-system modules. C_bus channel 272 may be a semi-conductor, or electrical path or bus or any hardware synchronous or asynchronous communication technologies provided the speed of communication is matched to the aggregate bandwidth requirements of a plurality of module to action control module communication pathss 58, 60, 62 and bus extender 274. The bus extender 274 allows I_bus channel 270 and C_bus channel 272 to be extended to a plurality of other server-node sub-systems 55.

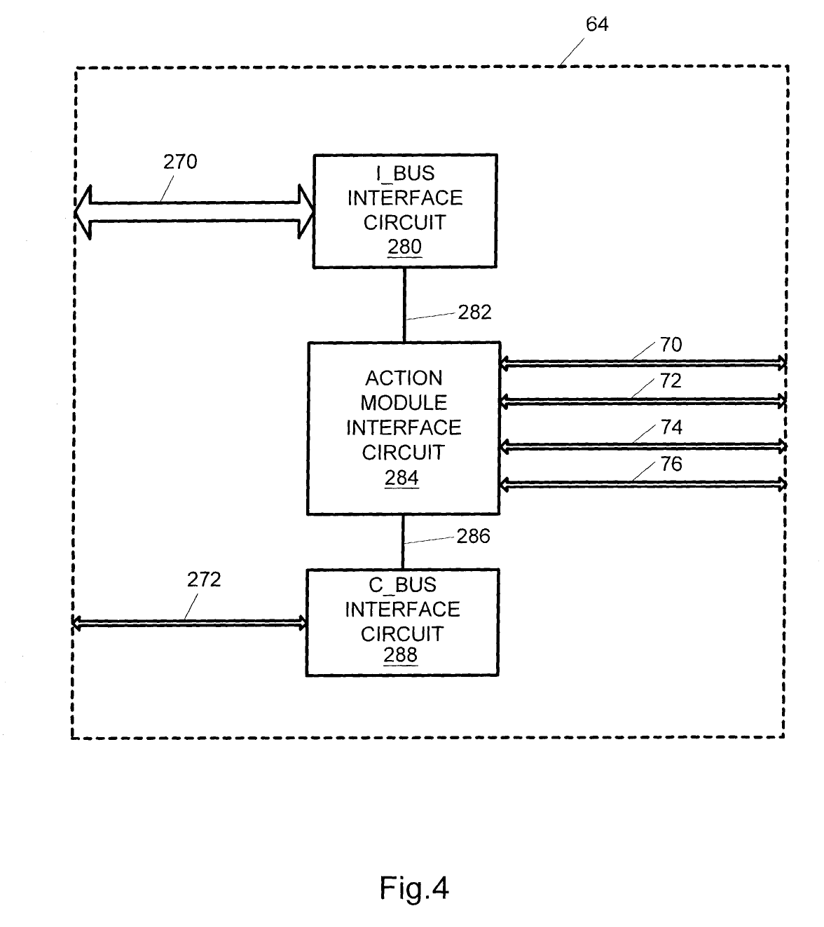

FIG. 4: Action Control Module Sub-System

FIG. 4 illustrates the action control module 64, which includes an Ibus interface circuit 280 designed according the technology chosen for the I_bus channel 270. For example, if the protocol used by the I_bus channel 270 is Ethernet then the I-bus interface circuit 280 includes an Ethernet PHY and framer chip, which those skilled in the art can easily design. The I_bus interface circuit 280 transfers information to the action module interface circuit 284 via the interconnect circuit between the I_bus interface circuit and the action module interface circuit 282. The interconnect circuit 282 may be a semi-conductor, or electrical path or bus or any hardware synchronous or asynchronous communication technologies provided the speed of communication is matched to the aggregate bandwidth requirements of a plurality of the interconnections between action control module and the action module 70, 72, 74 and 76. The action module interface circuit 284 takes I_bus protocol commands received from the interface circuit 282 and transforms them into signals suitable for the action module interfaces 70, 72, 74 and 76, discussed earlier. The interface circuit 284 also transforms signals from the interconnections between action control module and the action module 70, 72, 74 and 76 into protocol responses to send to the I_bus interface circuit 280 via the interconnect circuit between the I_bus interface circuit and the action module interface circuit 282. The circuit used in the action module interface circuit 284 will vary according the technology chosen for the interconnections between action control module and the action module 70, 72, 74 and 76 as discussed earlier. For example if the protocol used by the interconnection between action control module and the action module 70 is Ethernet then it includes an Ethernet PHY and framer chip. The action control module 64 includes a C_bus interface circuit 288 that is designed according the technology chosen for C_bus channel 272. For example if the protocol used by C_bus channel 272 is Ethernet then it includes an Ethernet PHY and framer chip. C_bus interface circuit 288 transfers information to the action module interface circuit 284 via the interconnect circuit between the C_bus interface circuit and the action module interface circuit 286. The interconnect circuit between the C_bus interface circuit and the action module interface circuit 286 may be a semi-conductor, or electrical path or bus or any hardware synchronous or asynchronous communication technologies provided the speed of communication is matched to the aggregate bandwidth requirements of a plurality of the interconnections between action control module and the action module 70, 72, 74 and 76.

The action module interface circuit 284 takes C_bus protocol commands received from the C_bus interconnect circuit 286 and transforms them into signals suitable for the interconnections between action control module and the action module 70, 72, 74 and 76. The action module interface circuit 284 also transforms signals from the interconnections between action control module and the action module 70, 72, 74 and 76 into protocol responses to send to the C_bus interface circuit 288 via the interconnect circuit between the C_bus interface circuit and the action module interface circuit 286.

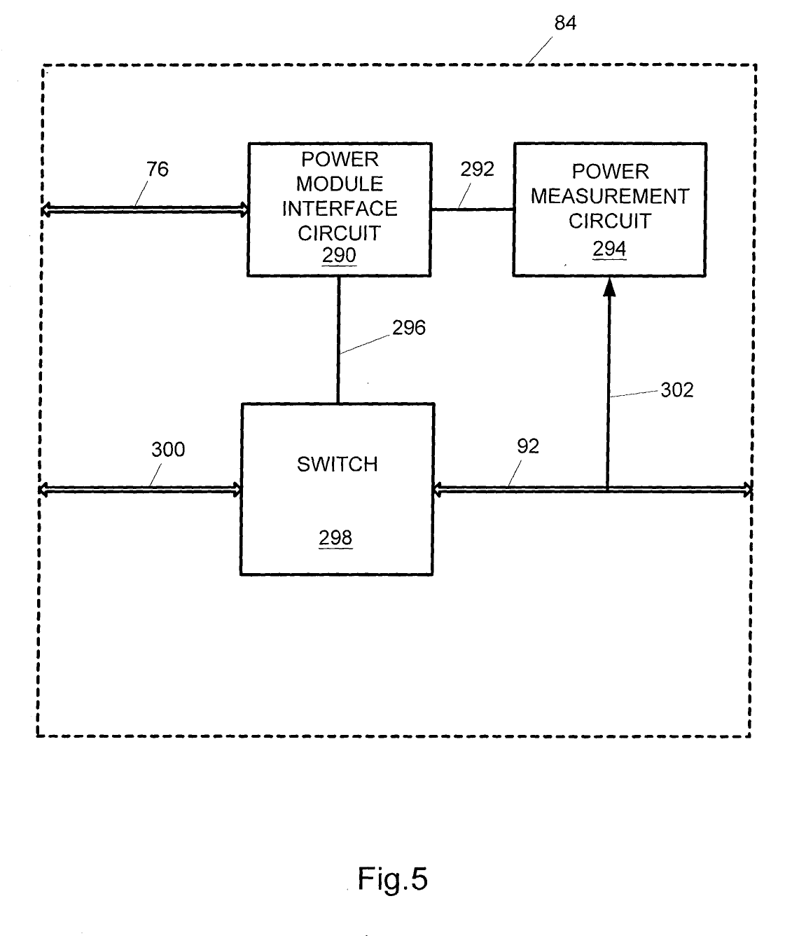

FIG. 5. Power Action Module

FIG. 5 illustrates the power module 84, which includes a power module interface circuit 290 that interfaces to the interconnection between action control module and the power module 76, a switch 298 and a power measurement circuit 294. The power action 84 also includes a power switch 298 that connects or disconnects power from the supply on a power source interface 300 to the equipment to be powered on the interface between equipment and power module 92. The power switch 298 can also be used to switch power produced by the equipment where the equipment is some type of specialized power supply or adjustable voltage source. The power measurement circuit 294 senses voltage on the interface between equipment and power module 92 through a power measurement connection 302. This measurement circuit can also be used to measure current produced by the equipment. The power module interface circuit 290 includes a circuit to detect signals from the interconnection between action control module and the power module 76 according to the technology chosen for that module as explained earlier. For example, if the protocol used by the interconnection between action control module and the power module 76 is Ethernet then the power module interface circuit 290 includes an Ethernet PHY and framer chip. The power module interface circuit 290 also includes a circuit to control the power switch 298 via the interconnection between power module control circuit and power switch 296. The design of this circuit depends on the type of power being switched between the power source interface 300 and the interface between equipment and power module 92, and also the technology used to implement the switch 298. For example, if the power being switched is commercial AC current (e.g., nominal 120V, 60 Hz in USA) then the power switch 298 may be implemented using a simple Triac and the interconnection between power module control circuit and power switch 296 need be only an RC circuit providing bias current for the Triac. The power module interface circuit 290 also includes a circuit to receive power measurements from the power measurement circuit 294 via the interconnection between the power module interface circuit and the power measurement circuit 292, and to transfer the measured data to the interconnection between action control module and the power module 76. These measurement circuits may be included as a part of the control of the power switch 298. In the current example the power module interface circuit 290 may receive a command from the interconnection between action control module and the power module 76 to switch power from on state to off state but delay toggling the switch off until the power measurement circuit 294 reports that the AC cycle has reached a zero crossing point, thereby minimizing electrical spikes on the interface between equipment and power module 92. Those skilled in the art recognize that there the power interface circuit 290 described above is simple and can be implemented in a variety of ways. The power switch 298 may be implemented using a variety of technologies, depending on the power requirements of the equipment interface 92. To follow the same AC example, the power switch 298 may be implemented using a simple Triac or SCR circuit, but may also be implemented using a variety of alternative means such as electromechanical devices, relays, thermocouples and mechanical switches, or any other means which has adequate switching voltage and current capabilities to suit the requirements of the interface between equipment and power module 92.

The power measurement circuit 294 measures current and voltage through the power measurement connection 302. Measurement of voltage and current may be accomplished using a number of prior art circuit methods. Those of ordinary skill in the art recognize that the power measurement circuit 294 described above is simple and can be implemented in a variety of ways. Using the current AC example, a transformer coupled to the interface between equipment and power module 92 with a high winding ratio and high resistance with the secondary coil connected to the power measurement circuit 294 provides a proportional low voltage for measurement by the power measurement circuit 294. A series resistor or a current transformer can provide a signal for current measurement. Other design approaches known to those of ordinary skill in the art include the use as operational amplifiers, opto-isolators, and rectifiers to condition signals for measurement. Opto-isolators, transformers and the like may be used for isolation and protection from high voltages. Some of these alternatives may be preferred depending on the specific application.

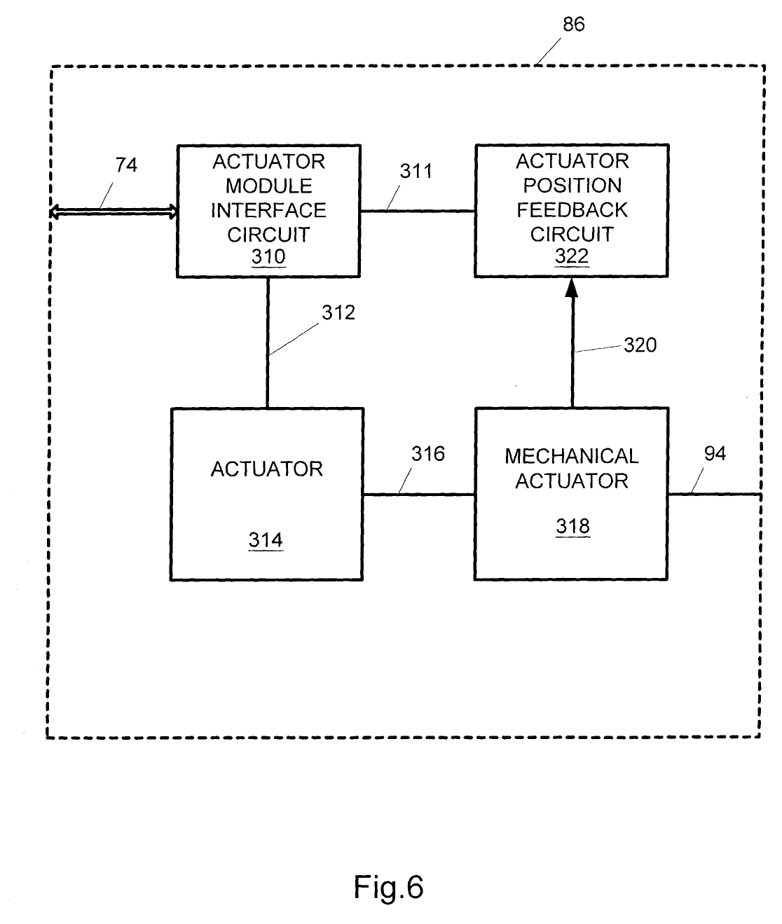

FIG. 6: Servo Action Module

FIG. 6 illustrates the servo module 86, which includes an actuator module interface circuit 310 that interfaces to the interconnection between action control module and the servo module 74, an actuator 314 and an actuator position feedback circuit 322. The actuator 314 supplies motive force via a mechanical interface 316 to a mechanical actuator 318. The mechanical actuator 318 transforms the motive force input from the mechanical interface 316 to the interface between equipment and servo module 94, and also provides positional information to the actuator position feedback circuit via an interface 320. The actuator position feedback circuit 322 senses position information on the interconnection between the mechanical actuator and the feedback circuit 320 and transfers a coded positional signal to the actuator module interface circuit 310 via the interconnection between the actuator position feedback circuit and actuator module interface circuit 311. The actuator module interface circuit 310 includes a circuit to detect signals from the interconnection between action control module and the servo module 74 according to the technology chosen for the interconnection between action control module and the servo module 74. For example, if the protocol used by the interconnection between action control module and the servo module 74 is Ethernet then the actuator module interface circuit 310 includes an Ethernet PHY and framer chip.

The actuator module interface circuit 310 also includes a circuit to control the actuator 314 via the interconnection between the actuator module interface circuit and the actuator 310.2. The design of this interface circuit depends on the type of actuator 314 being used. For example, if the actuator 314 being controlled is a commercial DC, analog Futaba® micro servo then this portion of the actuator module interface circuit 310 can be implemented using a commercial servo controller circuit available from Futaba and the interconnection between the actuator module interface circuit and the actuator 312 need only be three wires as required by such servo units. The actuator module interface circuit 310 also includes a circuit to receive encoded position signals from the actuator position feedback circuit 322 via the interconnection between the actuator position feedback circuit and actuator module interface circuit 311, to transfer the measured data to the interconnection between action control module and the servo module 74 and may also include circuits to use the signals as a part of the control of the actuator 314. In the current example the actuator module interface circuit 310 may receive a command from the interconnection between action control module and the servo module 74 to move the mechanical actuator 318 from a current position to a new position, but may calibrate the speed or acceleration of its movements according to positional data from the actuator position feedback circuit 322, thereby minimizing overshoots on the interface between equipment and servo module 94.

Those skilled in the art recognize that the actuator module interface circuit 310 described above is simple and can be implemented in a variety of ways. The actuator 314 may also be implemented using a variety of technologies, depending on the motion and force requirements needed to operate the interface between equipment and servo module 94. To follow a consistent example as above, if the motion required by the interface between equipment and servo module 94 is a push-button with a stroke distance of 0.2 centimeters and a force of 0.05 Kg, then the Futaba micro-servo mentioned above provides a good solution. The unit may also be implemented using a variety of alternative means such as electromechanical devices, servos, electromagnets, or any other means which has adequate force and motion required to suit the requirements of the interface between equipment and servo module 94. Those skilled in the art recognize that there the actuator 314 described above is simple and can be implemented in a variety of ways. The mechanical actuator 318 transfers mechanical motion of 314 to the exact mechanical motion required of the interface between equipment and servo module 94. In the present example, the Futaba micro-servo produces a 180-degree rotary motion according to the commands on the interconnection between the actuator module interface circuit and the actuator 312. The mechanical actuator 318 transfers mechanical motion of the actuator 314 to the exact motion required by the interface between equipment and servo module 94. The mechanical actuator 318 in this case may include a simple lever attached to the wheel that is pushed through a static grommet as the wheel turns. A position feedback indicator may be a simple slide potentiometer that presents a specific resister value at its terminals depending on its position. Those skilled in the art recognize the mechanical actuator 318 described above is simple and can be implemented in a variety of ways. The actuator position feedback circuit 322 measures position by means of the interconnection between the mechanical actuator and the feedback circuit 320. Using the present example, measurement of voltage across the terminals of the slide potentiometer accomplishes this function easily, using a number of prior art circuit methods. Those skilled in the art recognize that the actuator position feedback circuit 322 described above is simple and can be implemented in a variety of ways. Other design approaches are feasible, and may be preferred depending on the specific application.

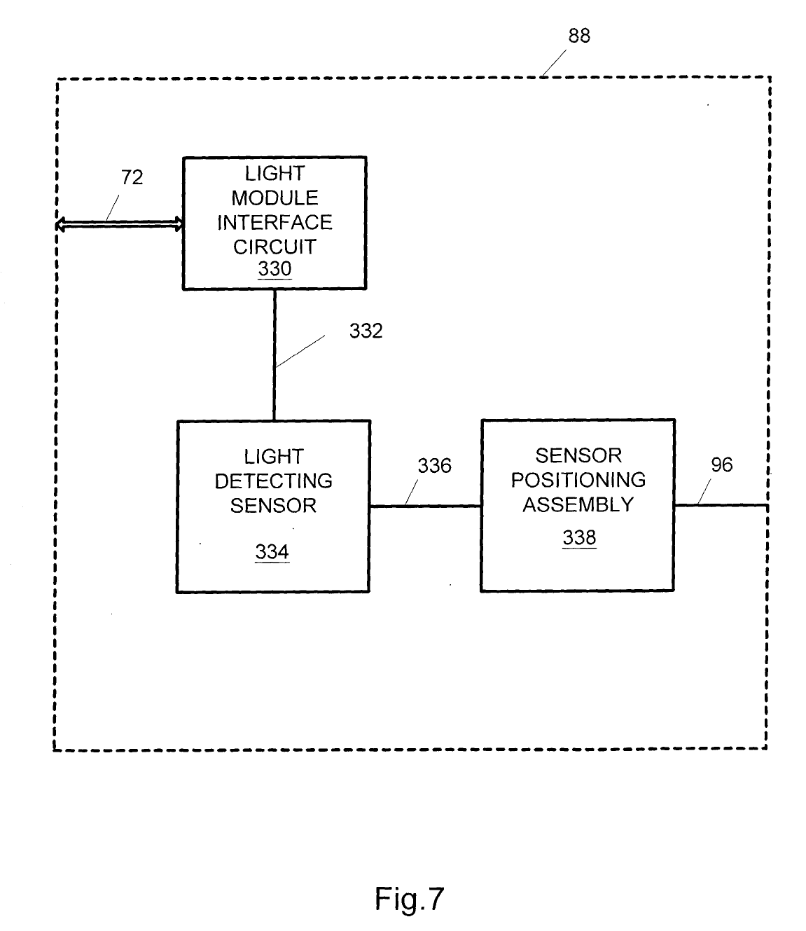

FIG. 7: Light Action Module

FIG. 7 illustrates the light action module 88, which includes a light module interface circuit 330 that interfaces to the interconnection between action control module and the light module 72, to a light detecting sensor 334. The light module 88 also includes a sensor positioning assembly 338 which connects the light detecting sensor 334 via the interconnection between he light detecting sensor and the sensor positioning assembly 336 to a light source on the equipment interface 96. The light module interface circuit 330 includes a circuit to detect signals from the interconnection between action control module and the light module 72 according to the technology chosen for the interconnection between action control module and the light module 72 as explained earlier in relation to similar interfaces. For example, if the protocol used by the interconnection between action control module and the light module 72 is Ethernet then the light module interface circuit 330 includes an Ethernet PHY and framer chip. The light module interface circuit 330 also includes a circuit to control the light detecting sensor 334 via the interconnection between the light module interface circuit and light detecting sensor 332. The design of this interface circuit depends on the type of light detecting sensor 334 being used. For example, if the light detecting sensor 334 being controlled is a photoresistor, then the light module interface circuit 330 may be implemented using a simple resistor and the interconnection between the light module interface circuit and light detecting sensor 332 need only be two wires as required by such simple circuits. Those skilled in the art recognize that the light module interface circuit 330 described above is simple and can be implemented in a variety of ways. The light detecting sensor 334 may be implemented using a variety of technologies, depending on the intensity, ambient light discrimination, pulse width and color sensing requirements to sense on the interface between equipment and light module 96. To follow a consistent example as above, suppose the light required at the interface between equipment and light module 96 is simply a white light source and is either on or off but does not pulse. Then a simple photoresistor mentioned above provides a good solution, but the circuit may also be implemented using a variety of alternative means such as photodiodes, phototransistors, photocells and CCD camera elements, or any other means which has adequate features required to suit the requirements of the interface between equipment and light module 96. Essentially, the light sensing detector 334 can be implemented to detect either or both the intensity and the wavelength of incident light. The sensor positioning assembly 338 transfers light energy from the interface between equipment and light module 96 to the sensor input 336 of the light detecting sensor 334. In the present example, a flexible plastic light pipe may be used to direct the light energy. Those skilled in the art recognize the sensor positioning assembly 338 described above is simple and can be implemented in a variety of ways. Other design approaches are feasible, such as fiber optic channels, mirrors, transducers and others may be preferred depending on the specific application.

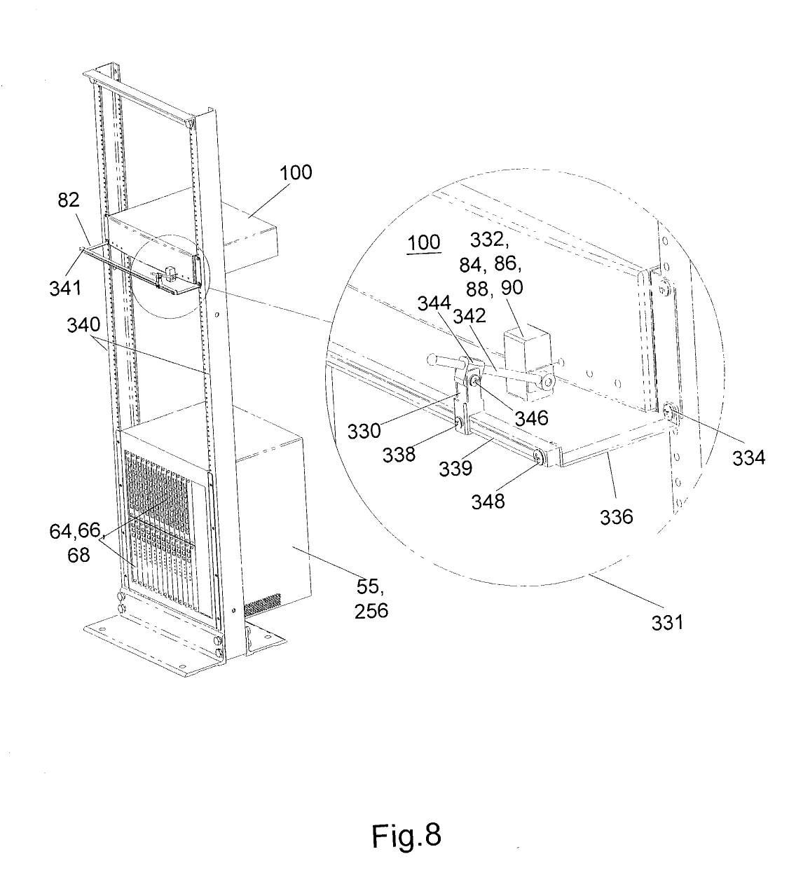

FIG. 8 Perspective View of Preferred Embodiment

FIG. 8 illustrates a preferred embodiment of server system controller and interconnect back plane 256 of the server node subsystem 55, the sub-server modules 64, 66, and 68, the action module positioner 82 and an example action module 90. Not shown is the interconnection between the action control module 64 and the action module 90. This has been left out for simplicity of drawing, however the preferred embodiment of the invention uses a cable for the interconnection running between the action control module 64 and the action module 90. A preferred embodiment of the server system controller and interconnect back plane 256 is installed in a vertical rack 340 along with the equipment 100 that it is controlling. The expanded view of the action module assembly 331 illustrates a preferred embodiment of the action module positioner 82, which includes a horizontal bar 339 to a position bracket 330 at a precise horizontal position which is locked by a screw 338. The horizontal positioning bar 339 is held firmly in place by a horizontal bracket 336, a rack fastening screw 334, a horizontal positioning locking screw 348 and a horizontal positioning bar hinge 341. A vertical positioning bracket 344, a vertical positioning rod 342 and a vertical positioning rod locking screw 346 provide precise and stable vertical positioning of the action module 90. A horizontal positioning bar hinge 341 enables the entire assembled action module positioner 82 to swing away from the equipment 100 enabling easy access to the equipment 100 and easy recovery of current precise positions when the action module positioner 82 is swung back into place. It will be apparent to those of ordinary skill in the art that alternative mechanical packaging and positioning methods are feasible and may be more suitable depending on factors such as the type of interfaces being controlled and action modules used. For example, the positioner may be attached directly to the equipment if there is no suitable vertical rack 340 for attachment. Alternative special vertical rails may be added specifically for attaching mechanical positioners and action modules.

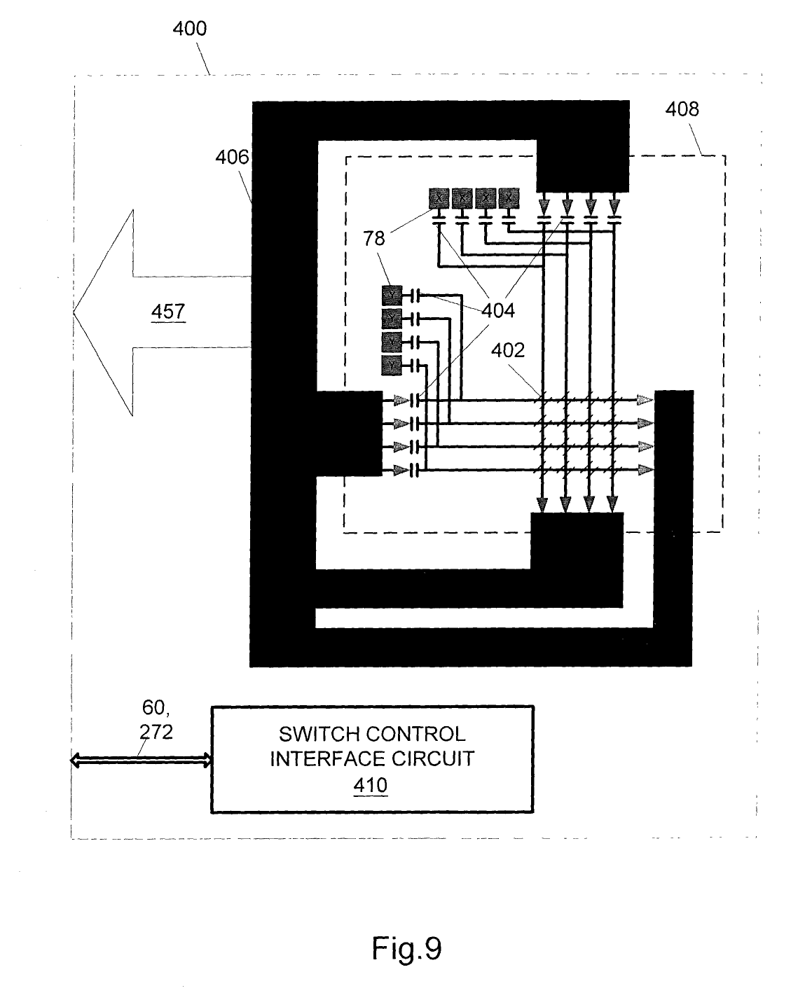

FIG. 9 Quad-4 Copper Switch Device

FIG. 9 illustrates the preferred embodiment of the Quad-4 copper switch device 400, which includes a Quad-4 copper matrix 408, Quad-4 routing circuits 406, a Quad-4 switch extension interface 457, Quad-4 switch control interface circuit 410, the C-bus channel 272 and the server module computer to switch module communications path 60. A set of multi-pole cross-point switches 402, Quad-4 interface switches 404 and the interface between equipment and switch module 78, provide interconnections for up to four circuits in the X direction and four circuits in the Y direction of an X-by-Y switch configuration. In other words, the Quad-4 device implements a 4-by-4, four wire relay switch crosspoints (4×4×4=64 connections). The multi-pole cross-connect switches 402 and the Quad-4 interface switches 404 may be mechanical relays, electronic relays, or other devices well known to those skilled in the art. The interface between equipment and switch module 78 may be any type of four-wire connector such as RJ45, which is popular for Ethernet 10/100Bt, T1 and E1. The Quad-4 switch control interface circuit 410 includes a circuit to detect signals from the C_bus channel 272 according to the technology chosen for the C_bus channel 272 as explained earlier and to transform them into switch signals directly connected to the Quad-4 copper matrix 408. For example, if the protocol used by the C_bus channel control bus 272 is Ethernet then the Quad-4 switch control interface circuit 410 includes an Ethernet PHY and framer chip.

It will be apparent by those of ordinary skill in the art that this Quad-4 copper switch device 400 may be used a lowest common denominator building block in much larger X-by-Y configurations that may be required for different configurations of the equipment 100. For example, a switch that requires 20 Ethernet connections on one piece of equipment to connect to either one or another piece of similar equipment would require a 20 by 40 switch arrangement, and could be configured using 20 Quad-4 devices in a 5×10 configuration. It will also be apparent from those of ordinary skill in the art that other conductor and connector types, such as groups of, SCSI, Firewire, USB, nine wire RS232, 25 wire RS232, two wire and four wire telephone pairs, XDSL, Gigabit Ethernet pairs may also be supported by arranging Quad-4 devices by changing the form of the equipment connectors at the interface between equipment and switch module 78.

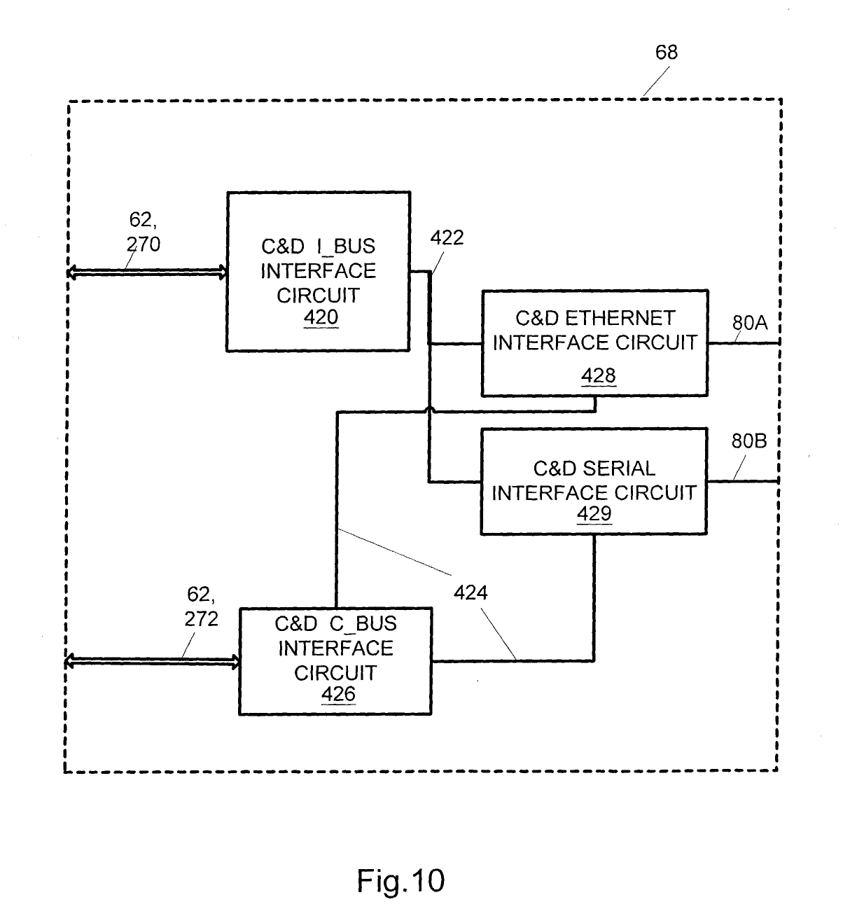

FIG. 10: Command and Display Sub-System

FIG. 10 illustrates the command and display module 68, which includes an command and display I_bus interface circuit 420 which interfaces with the I_bus channel 270 through the server module to command and display module communications path 62, to a plurality of command and display Ethernet interface circuits 428 and the command and display serial interface circuits 429 via the command and display internal I_bus interface 502. The command and display module 68 also includes a command and display C_bus interface circuit 426 which interfaces the C-bus channel 272 through the server module to command and display module communications path 62 to a plurality of command and display Ethernet interface circuits 428 or command and display serial interface circuits 429 via the command and display internal C_bus interface 424. The command and display Ethernet interface circuit 428 and the command and display serial interface circuit 429 connect to the equipment 100 via the user interface between equipment and command and display module 80A or 80B respectively. The command and display I-bus interface circuit 420 includes a circuit to detect signals from the I_bus channel 270 according to the technology chosen for that bus as explained earlier. For example, if the protocol used by the I_bus channel 270 is Ethernet then the command and display I-bus interface circuit 420 would include an Ethernet PHY and framer chip. The command and display internal C_bus interface 426 includes a circuit to detect signals from the C_bus channel 272 according to the technology chosen for that bus as explained above. For example, if the protocol used by the C_bus channel 272 is Ethernet then the command and display internal C_bus interface 426 would include an Ethernet PHY and framer chip. The command and display Ethernet interface circuit 428 is an Ethernet circuit, which includes an ETHERNET PHY and framer chip as those skilled in the art, can easily design. The command and display serial interface circuit 429 is a serial circuit. Other types of parallel or serial interface circuits in place of circuits 428 or 429 may be implemented using a variety of technologies, depending on the interface requirements of the user interface between equipment and command and display module 80. To follow a consistent example as above, suppose the user interface required at the user interface between equipment and command and display module 80 is a Telnet server function that is accessed via Ethernet, then a command and display Ethernet interface circuit 428 mentioned above would provide a good solution. Alternative means may also be available such as RS232, V.21 as required to suit the requirements of the user interface between equipment and command and display module 80. Those skilled in the art recognize that there the command and display Ethernet interface circuit 428 and the command and display serial interface circuit 429 described above can be implemented in a variety of ways and may be preferred, depending on the specific application.

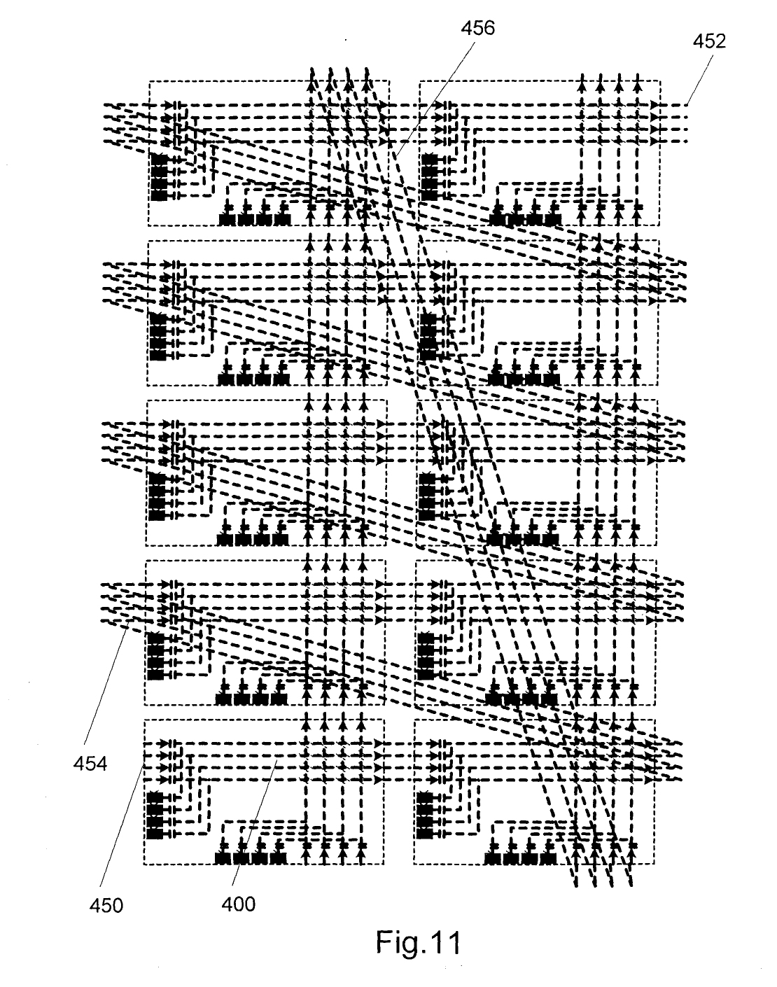

FIG. 11: Quad-4 Interconnections

FIG. 11 illustrates that a plurality of the Quad-4 copper switch device 400 may be interconnected vertically as shown by the Quad-4 Y interconnections 454 and horizontally as shown by the Quad-4 X interconnections 456 and cross-connected with other groups of Quad-4 devices through the Quad-4 Y1 extension interface 450 and the Quad-4 Y2 extension interface 452. This demonstrates the flexibility of the Quad-4 device and means that multiple circuit paths may be created for any two end-points. This feature greatly improves connection path redundancy and increases the utility of the resulting matrix.

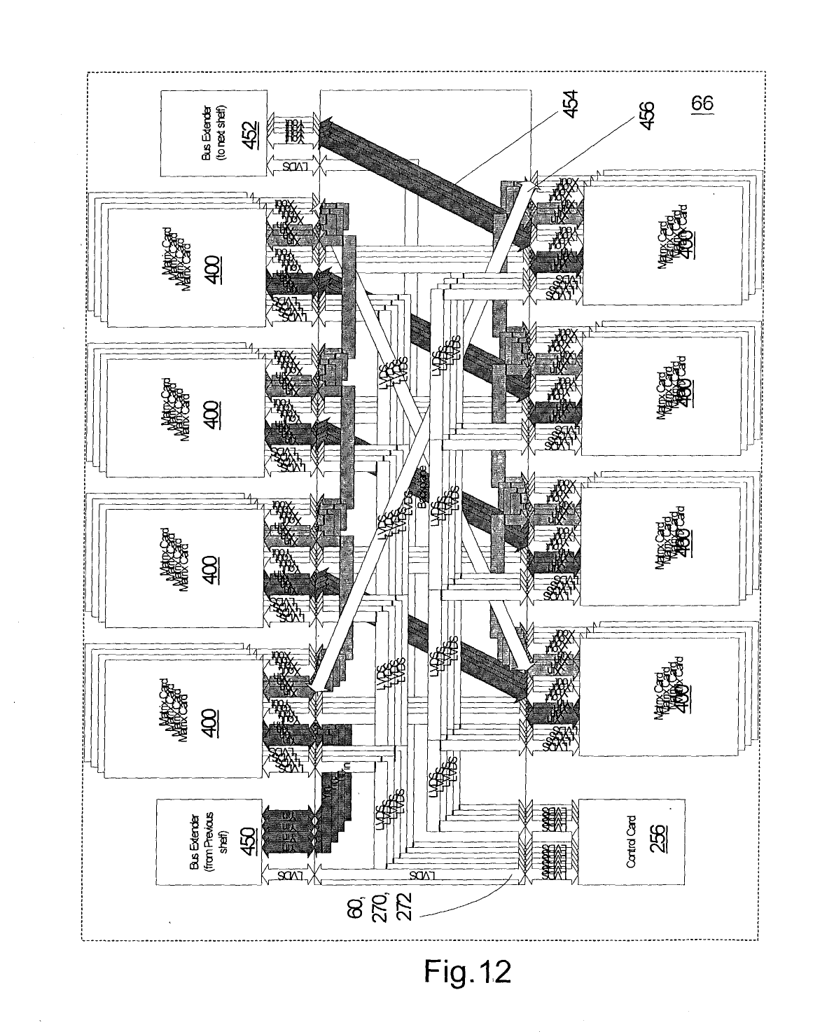

FIG. 12: Interconnection System

FIG. 12 illustrates an embodiment of one type of switch module 66 in which matrix systems comprised of a plurality of the Quad-4 copper switch device 400 may be multiply interconnected to the server system controller and interconnect back plane 256, and the Quad-4 Y1 extension interface 450 and the Quad-4 Y2 extension interface 452. The I_bus channel 270 and the C-bus channel 272 in this embodiment may use industry standard Ethernet or LVDS technology. This illustration also shows redundant Quad-4 Y interconnections 454 AND 456 Quad-4 X interconnections 456.

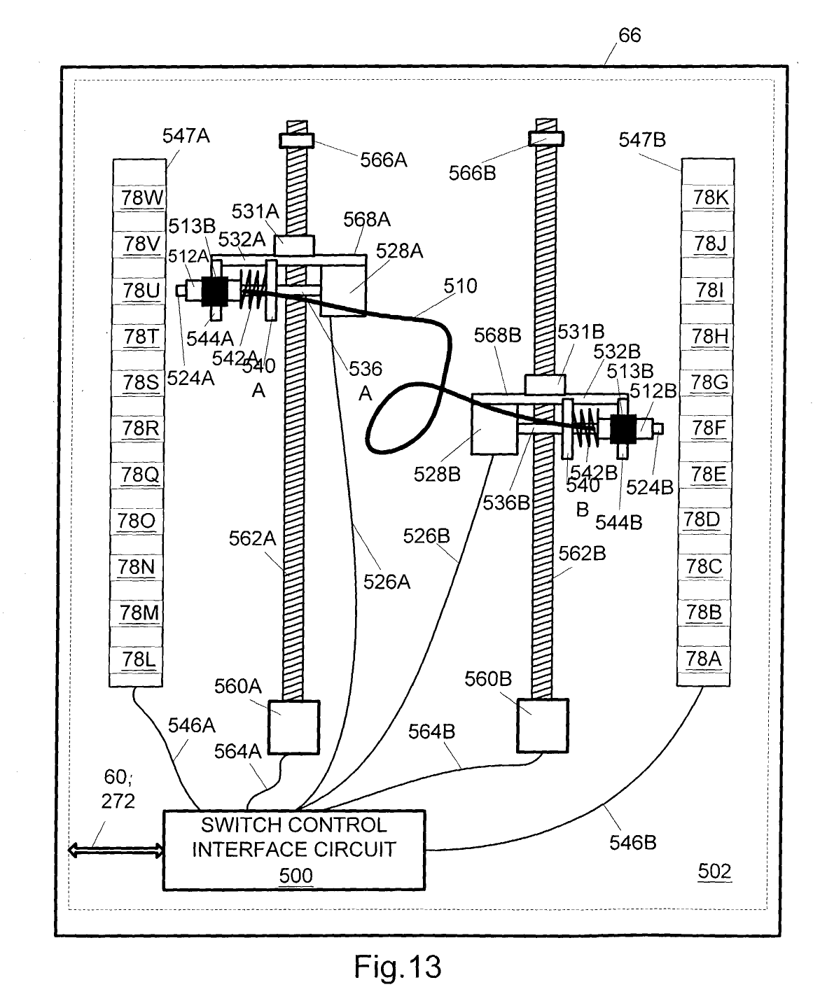

FIG. 13: Optical Switch Device

FIG. 13 illustrates a preferred embodiment of a low-cost optical switch device 502 suitable to construct an optical switch type of the switch module 66, to switch any two of the interface between equipment and switch module 78 of fiber optic type. In accordance with this embodiment, the optical switch includes an optical switch control interface circuit 500, fiber optic coupler blocks 547A and 547B, lead-screw assemblies 562A and 562B, fiber optic cable 510 and robotic fiber optic head-end positioners 568A and 568B. The optical switch control circuit 500 interfaces between the C_bus channel 272, the server module to switch module communications path 60, the stepper motor controls 564A and 564B and the position feedback sensors 546A and 546B. The optical switch control interface circuit 500 includes a C-bus interface circuit that is designed according the technology chosen for the C_bus channel 272 as discussed previously. In addition, the optical switch control interface circuit 500 includes functions to control the stepper motor units 560A and 560B in accordance with manufacturer's specific recommendations. Control commands received from the C_bus channel 272 are translated by the optical switch control interface circuit 500 into position change signals. The optical switch control Interface circuit 500 generates signals to the fiber connect actuators 528A and 528B and the stepper motor units 560A and 560B. When the fiber connect actuators 528A and 528B are energized, spring loaded fiber head-ends 524A and 524B are uncoupled from their current position on fiber optic coupler blocks 547A and 547B. The stepper motor units 560A and 560B move lead screw assemblies 562A and 562B, which in turn move the fiber optic head-end positioner 568A and 568B to the position required. Once the fiber optic head-end positioners 568A and 568B move the fiber head-ends 524A and 524B to a center alignment with the selected couplers at the interface between equipment and switch module 78A through 78W; at which time their new positions, verified by the fiber head-end alignment feedback circuits 546A and 546B, are signaled to the optical switch control interface circuit 500, which then signals the fiber optic head-end positioners 568A and 568B to release the spring-loaded fiber head-end 524A and 524B to engage the correct couplers at the interface between equipment and switch module 78A through 78W on fiber optic coupler blocks 547A and 547B. The construction of this low-cost optical switch device 502 will be clear to those of ordinary skill in the art of mechanics and electrical control of stepper motors. The fiber optic head-end positioner 568 are of simple, yet precise construction, The fiber optic head-end positioner 568 body parts include a traveler plate 532 which supports lead-screw coupler 531, and the head-end right angle bracket 544 and the spring retainer right angle bracket 540, any of which can be made of metal or stiff composite material for example. The fiber connect actuators 528A or 528B may be solenoids or other suitable actuators such as servomotors, and may be mounted on the traveler plates 532A, 532B or may be attached to the traveler plate 532. The fiber optic head casings 512A, 512B are mounted using a sliding collars 513A and 513B to head-end right angle bracket 544A, 544B. The fiber head-ends 524A and 524B are rigidly mounted within the fiber optic head screw casings 512A and 512B with the fiber-optic cable 510 extending though the rear of the fiber optic head screw casings 512A and 512B. The fiber optic head screw casings 512A and 512B are attached to plungers 536A and 536B, which are driven by the fiber, connect actuators 528A and 528B. When the actuators are energized to pull against the force of the springs 542A, 542B that otherwise hold the fiber optic head screw casings 512A and 512B and therefore fiber head-ends 524A and 524B in position on the fiber optic coupler blocks 547A and 547B. The low-cost optical switch device 502 illustrated in FIG. 13 allows any fiber cable attached to the outside of the fiber couplers at the interface between equipment and switch module 78A through 78K to be attached to any fiber cable attached to the outside of fiber couplers at the interface between equipment and switch module 78L through 78W by way of the position of the head ends connecting fiber optic 510. The couplers at the interface between equipment and switch module 78 may be of commercial fiber-to-fiber couplers suitable for use with a variety of optical fiber standards, including, but not limited to, single-mode, multi-mode, DWDM, OC3, OC12, OC48, OC192, OC768 and others. Fiber optic coupler blocks 547A and 547B are designed to accommodate the chosen coupler block type. In this way a variety of fiber optic cable technologies may be supported using the same switch technology, with minimal customization for each separate type. A plurality of low-cost optical switch device 502 may be used individually to form a switch module 66, or a plurality of low-cost optical switch devices 502 may be interconnected to form larger configurations of switch module 66. Those skilled in the art will recognize that number of couplers at the interface between equipment and switch module 78 on the low-cost optical switch devices 502 may be readily changed to add additional or reduced to fewer than the number shown, and still remain within the scope of this invention. It should be apparent that a number of simple variations of this device are feasible and remain within the scope of this invention. For example one end of the fiber may be fixed and the other end would be installed on a traveler assembly. Another simple derivation within the scope of this invention would include a design where the fiber head-end would be fixed to the traveler and instead of the head-end moving relative to the lead screw, the entire lead-screw assembly could be configured to move. An advantage of this optical switch device compared to those found in prior art includes low cost, simple user maintainability, high reliability, and remote operation. Also this approach may be used with any type of fiber technology, speeds and connector types. The switching speed is adequate for this application, where otherwise a human would be handling the cables at human speed.

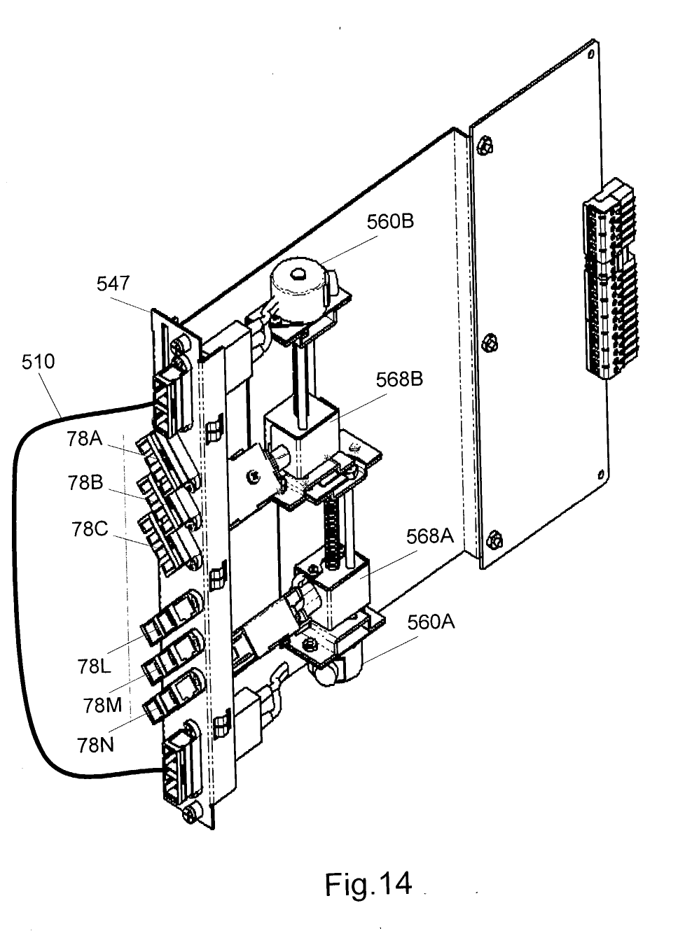

FIG. 14: Optical Switch Device Second Embodiment

FIG. 14 illustrates a derivation of a preferred embodiment of a low-cost optical switch device 502 suitable to construct switch module 66, of the optical switch type, that is suitable for applications of the present invention to switch any one of the interfaces between equipment and switch module 78A to 78C to any one of the interfaces between equipment and switch module connections 78L to 78N. In accordance with this illustration of the preferred embodiment, the low-cost optical switch device 502 includes stepper motor units 560A and 560B, fiber optic head-end positioners 568A and 568B and fiber optic cable 510.

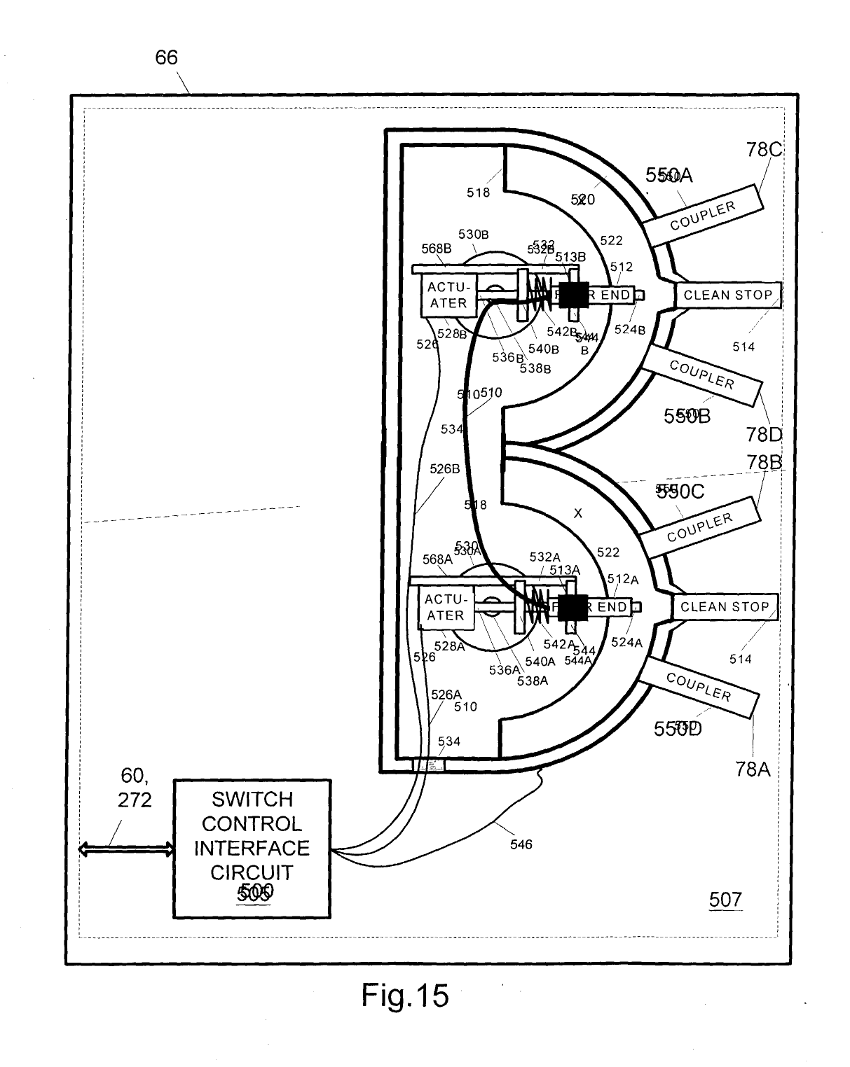

FIG. 15: Optical Switch Third Embodiment

FIG. 15 illustrates another embodiment of a low-cost optical switch device 507 suitable to construct a switch module 66 for applications of the present invention to switch two or more, optical interfaces between equipment and switch module 78. In accordance with this embodiment, the optical switch includes an alternative optical switch control interface circuit 505, pre-formed fiber optic coupler block 520, rotary servo assemblies 530A and 530B, fiber optic cable 510 and fiber optic head-end positioners 568A and 568B. The alternative optical switch control circuit 505 interfaces between the C_bus channel 272 and the server module computer to switch module communications path 60, rotary servo assemblies 530A and 530B and fiber head-end alignment feedback sensors 546A and 546B. The alternative optical switch control interface circuit 505 includes a C-bus interface circuit that is designed according the technology chosen for C-bus channel 272 as discussed previously. In addition, the alternative optical switch control interface circuit 505 includes functions to control the rotary servo assemblies 530A and 530B which are easily designed by those skilled in the art, in accordance with manufacturer's specific recommendations.

Control commands received from the C-bus channel 272 are translated by the alternative optical switch control interface circuit 505 into position change signals. The alternative optical switch control interface circuit 505 signals to the fiber connect actuators 528A and 528B and rotary servo assemblies 530A and 530B. When the fiber connect actuators 528A and 528B are energized, the spring loaded fiber head-ends 524A and 524B are uncoupled from their current position of optical coupler block 550A to 550D and the rotary servo assemblies 530A and 530B rotate on the rotary servo axis 538A and 538B the fiber optic head-end positioners 568A and 568B to the positions at the interfaces between equipment and switch module 78A, 78B, 78C or 78D as required. Once the fiber optic head-end positioners 568A and 568B move the fiber head-ends 524A and 524B to the selected positions, with their centers aligned to the selected couplers at the interfaces between equipment and switch module 78A through 78D, then their positions, as verified by selected fiber head-end alignment feedback circuit 546, is signaled to the alternative optical switch control interface circuit 505, which then signals the fiber optic head-end positioners 568A and 568B to release the spring-loaded fiber head ends 524A and 524B, causing them to engage in the correct couplers at the interfaces between equipment and switch module 78A through 78D in the pre-formed fiber optic coupler block 520. The construction of this embodiment of a low-cost optical device 507 is clear to those skilled in the art of mechanics and electrical control of servomotors. The fiber optic head-end positioners 568A and 568B are of simple, yet precise construction, The fiber optic head-end positioner 568A and 568B body parts include the traveler plates 532A and 532B, which support rotary servo assemblies 530A and 530B, and head-end right angle brackets 544A and 544B and spring retainer right angle brackets 540A and 540B, any of which can be made of metal or stiff composite material for example. The fiber connect actuators 528A and 528B may be solenoids or other suitable actuators such as servo motors, are mounted on 25 the traveler plates 532A and 532B. Ends of the fiber optic cable are rigidly mounted within the fiber optic head screw casings 512A and 512B with the cable 510 extending though the fiber optic head screw casings 512A and 512B. The fiber optic head screw casings 512A and 512B are attached to plungers 536A and 536B, which are driven by fiber, connect actuators 528A and 528B. When the actuators are energized to pull against the force of springs 542A and 542B that otherwise holds the fiber optic head screw casings 512A and 512B and therefore fiber head-ends 524A and 524B in positions of the pre-formed fiber optic coupler block 520. This embodiment of a low-cost optical device 507 allows any fiber cable attached to the outside of the fiber couplers at the interfaces between equipment and switch module 78A through 78B to be attached to any fiber cable attached to the outside of fiber couplers at the interfaces between equipment and switch module 78C through 78D by way of the position of the fiber head ends 524A and 524B connecting fiber 510. The slotted shield wall 518 is a preformed barrier that separates the mechanism of the fiber optic head-end positioners 568A and 568B from the fiber head-ends 524A and 524B so as to reduce the number of floating particles near the head ends. The clean stop 514 is a fixed position of the switch where the fiber head end may be parked for cleaning purposes or when it is not used. Fiber couplers 550A to 550D at the interfaces between equipment and switch module 78 may be of commercial fiber-to-fiber couplers suitable for use with a variety of optical fiber standards, including, but not limited to, single-mode, multi-mode, DWDM, OC3, OC12, OC48, OC192, OC768 and others including but not limited to LC or SC type. The pre-formed fiber optic coupler block 520 is designed to accommodate the chosen coupler block type. In this way a variety of fiber optic cable technologies may be supported using the same switch technology, with minimal customization for each separate type. This embodiment of a low-cost optical device 507 may be used individually to form a switch 66, or a plurality of the low-cost optical device 507 may be interconnected to form larger configurations of switch 66. Those skilled in the art will recognize that number of interface couplers at the interfaces between equipment and switch module 78 on this embodiment of the low-cost optical device 507 may be changed within the scope of this invention. The primary advantage of this optical switch device compared to those found in prior are include low cost, user maintainability, high reliability, and remote operation and the ability to use any kind of fiber The switching speed is adequate for this application, where otherwise a human would be handling the cables at human speed.

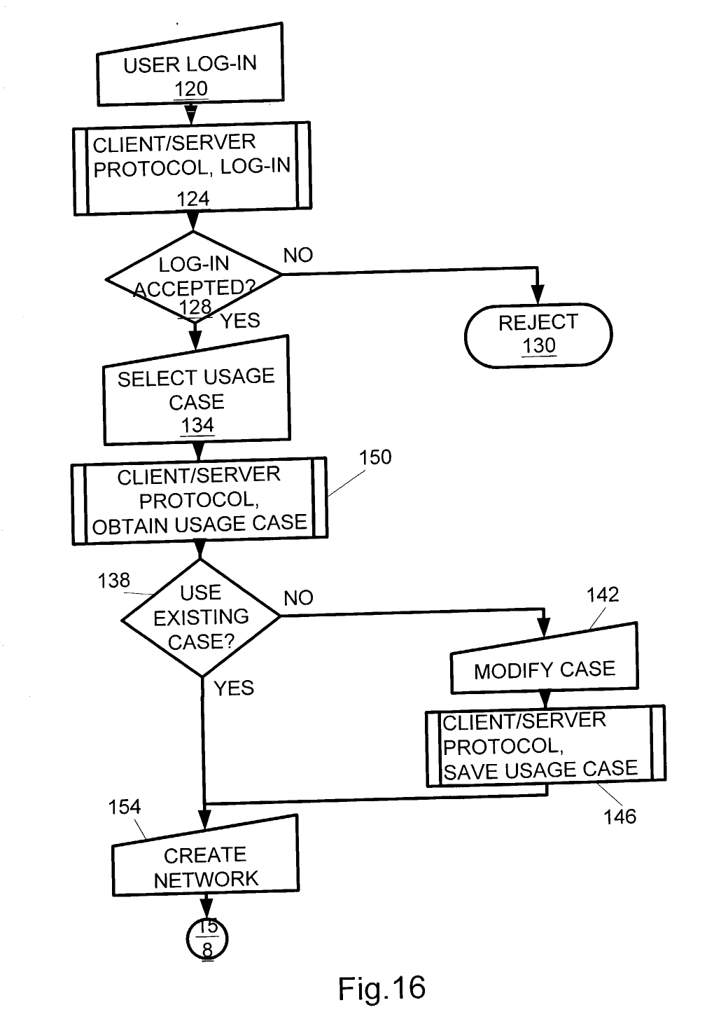

FIGS. 16, 17 and 36 through 44: Software Operation of the Client Application

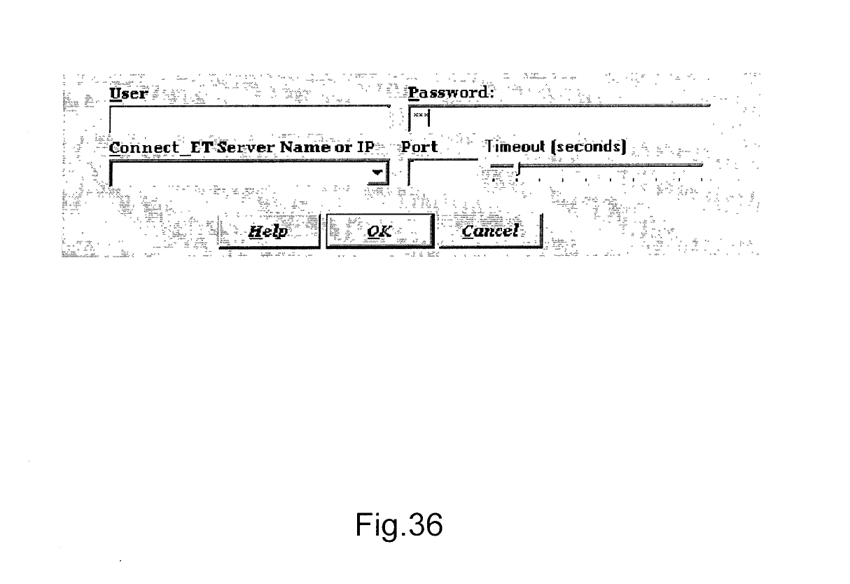

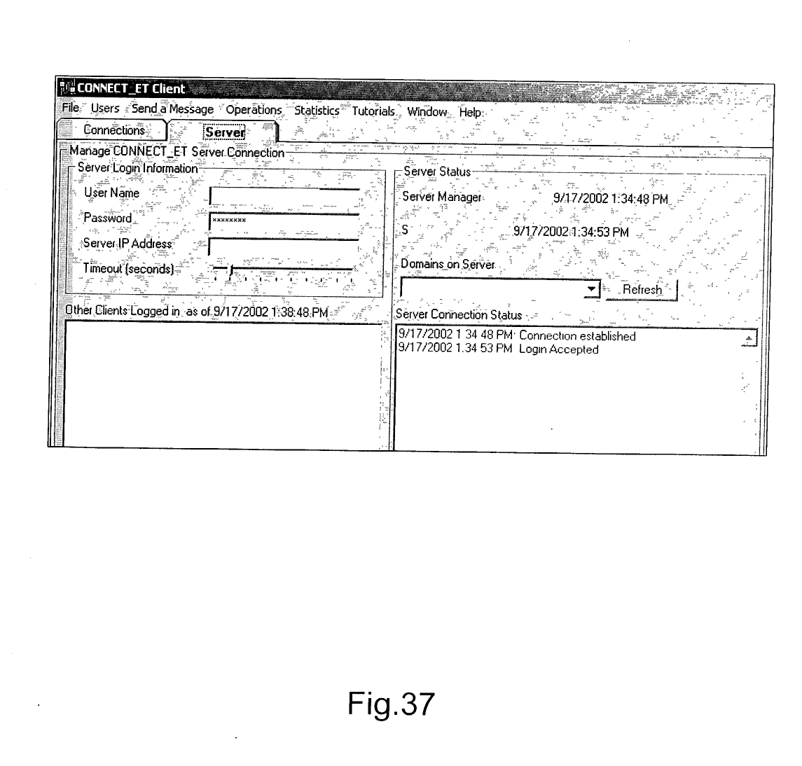

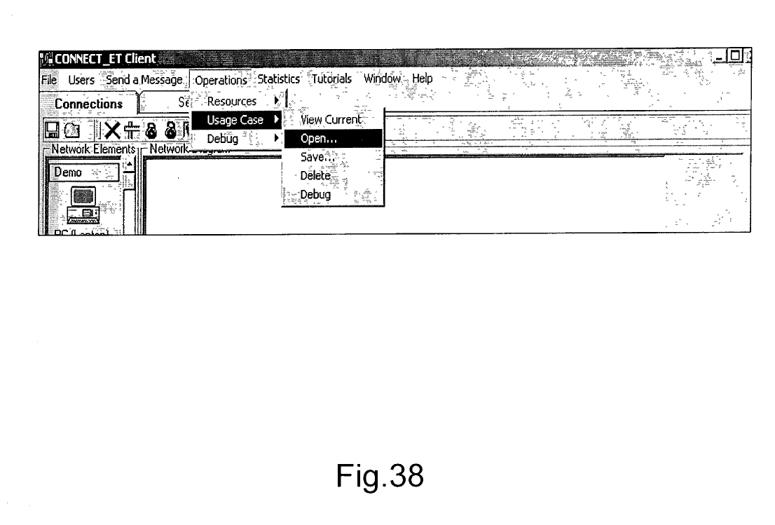

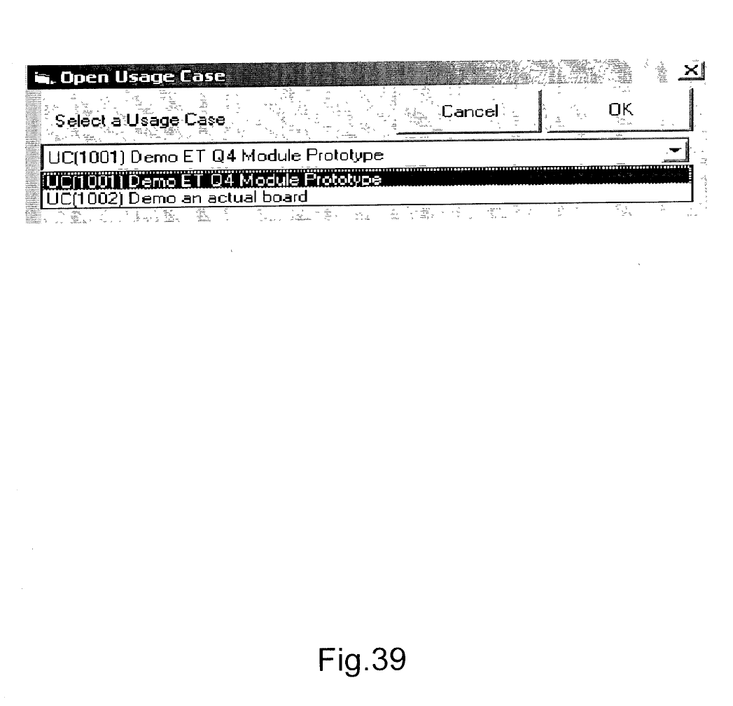

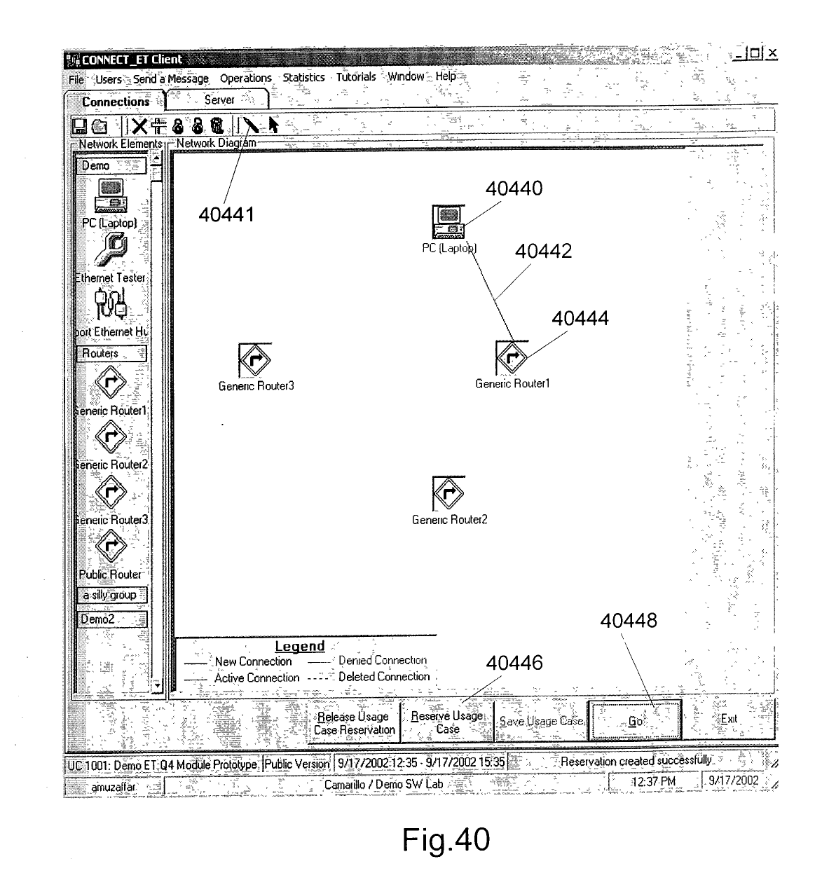

FIG. 16 illustrates the main software logic flow of the illustrated embodiment of the client application software. According to the illustrated embodiment, any user of the system is assigned a name and password in order to log into the system as shown by input 120. FIG. 36 illustrates the layout of the illustrated embodiment of the graphical user of the log-in screen to implement this input. As indicated in process 124, once the user enters the user-name and password, the client application transmits the information to the server, and the server replies with a message to accept the log-in or not, as indicated by test 128. If the server does not accept then the user log-in is rejected according to step 130. If the server does accept the user log-in, the user may verify the connection to the server as indicated in FIG. 37. Once logged-in the user will usually click open an existing usage case as illustrated by FIG. 16 step 134 (see FIG. 38 and FIG. 39). According to FIG. 16 step 150, the client requests a copy of the desired usage case from the server using the client/server protocol process, and the usage case connections screen (see FIG. 40) is displayed with the appropriate graphical representation of the usage case information.

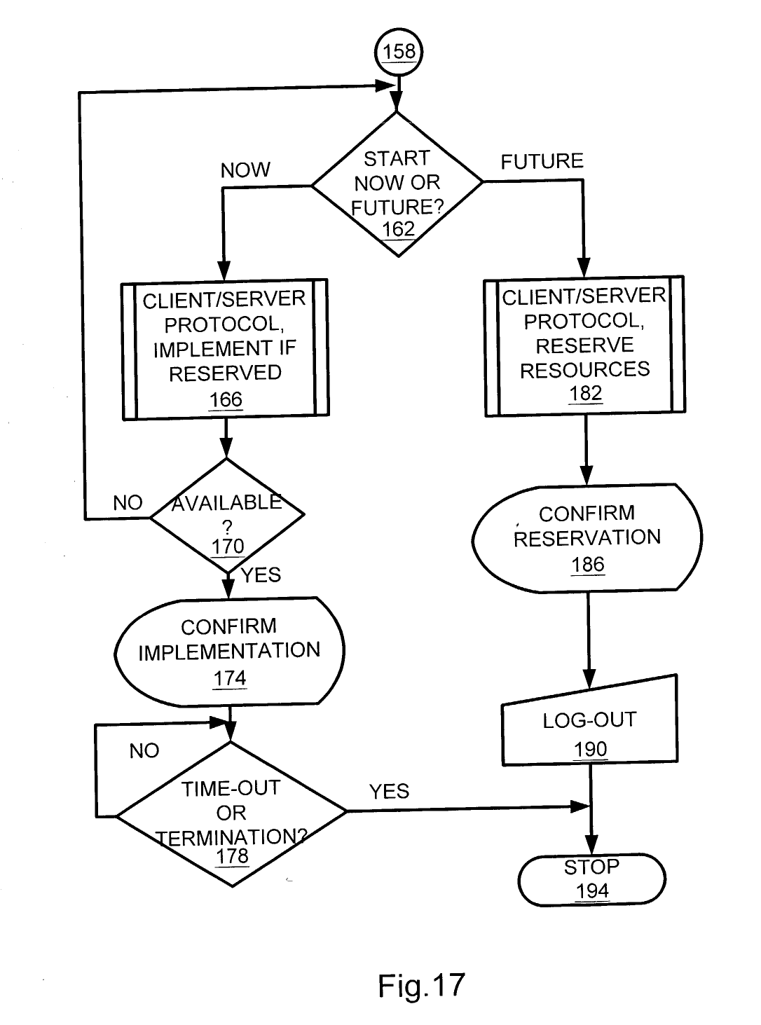

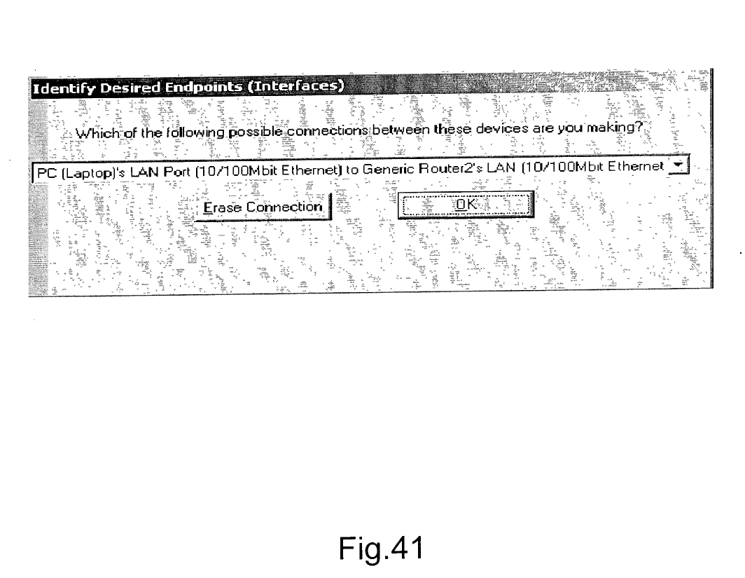

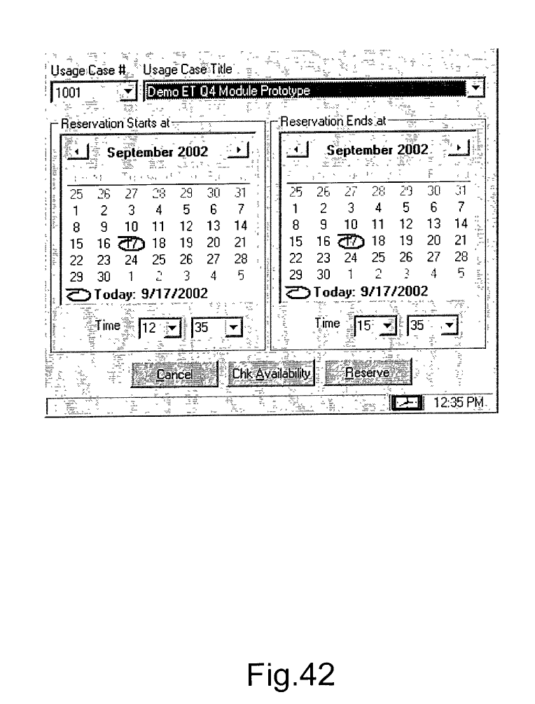

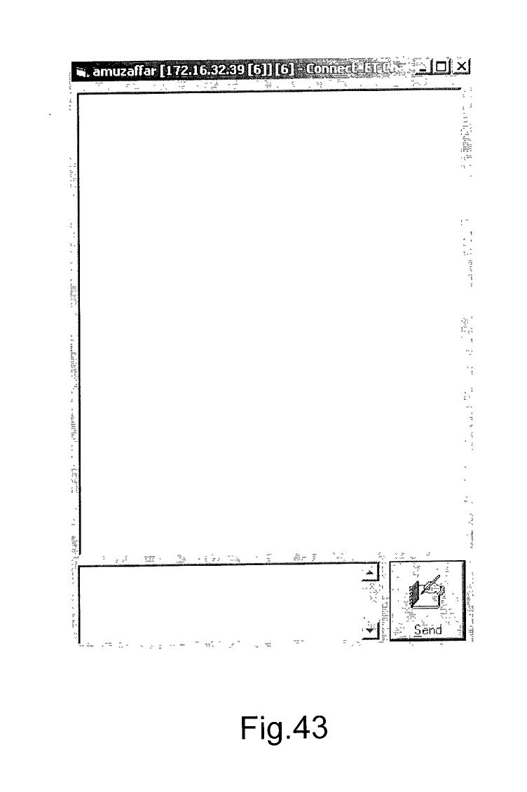

At this point the user has the choice of using the case as displayed or of modifying it as should in FIG. 40. For example, the user may create a connection 40442 (FIGS. 40 and 41) between two devices 40440 and 40444 using a drawing tool 40441. Once the user is satisfied with the network diagram, the Reserve Usage Case button 40446 is clicked to schedule the case for implementation according to a drop down menu (FIG. 42). Once a schedule has been selected, the user may click the “Go” button 40448 (FIG. 40), which schedules the configuration for implementation according the schedule selected (FIG. 16 step 154 and FIG. 17 step 166). If the reserved resources are available, according to test step 170 (FIG. 17), then the client receives confirmation according to FIG. 17 step 174. Alternatively, if the schedule is for future, the client sends the reservation to the server according to FIG. 17 step 182 and the server will not implement the configuration until the scheduled time occurs and the client is signaled to confirm the reservation according to FIG. 17, step 186. According the illustrated embodiment and FIG. 43 the users may also exchange quick messages without leaving the client environment to a third party email system. This feature is useful because it reduces the number of steps required to stay in communication with other system users while using the client. In addition to configuration actions, the client software also has a feature to communicate with robotic action modules (FIG. 1 items 84, 86, 88 and 90).

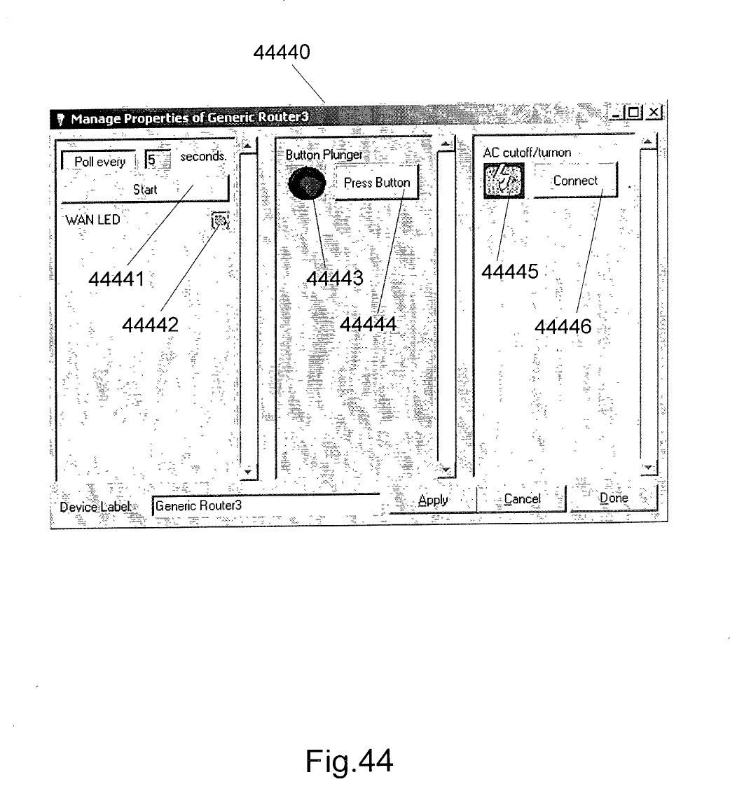

FIG. 44 item 44440 is an embodiment of the user interface directed to these robotics action modules. The user interface to the power module 84 includes a power control button 44446 and power indicator 44445. The user interface to the servo module 86 includes a control button 44444 and position indicator 44443. The user interface to the light module 88 includes control button 44441 and indicator 44442. The specific user interface layout 44440 and features is specific to the each specific action module function 90.

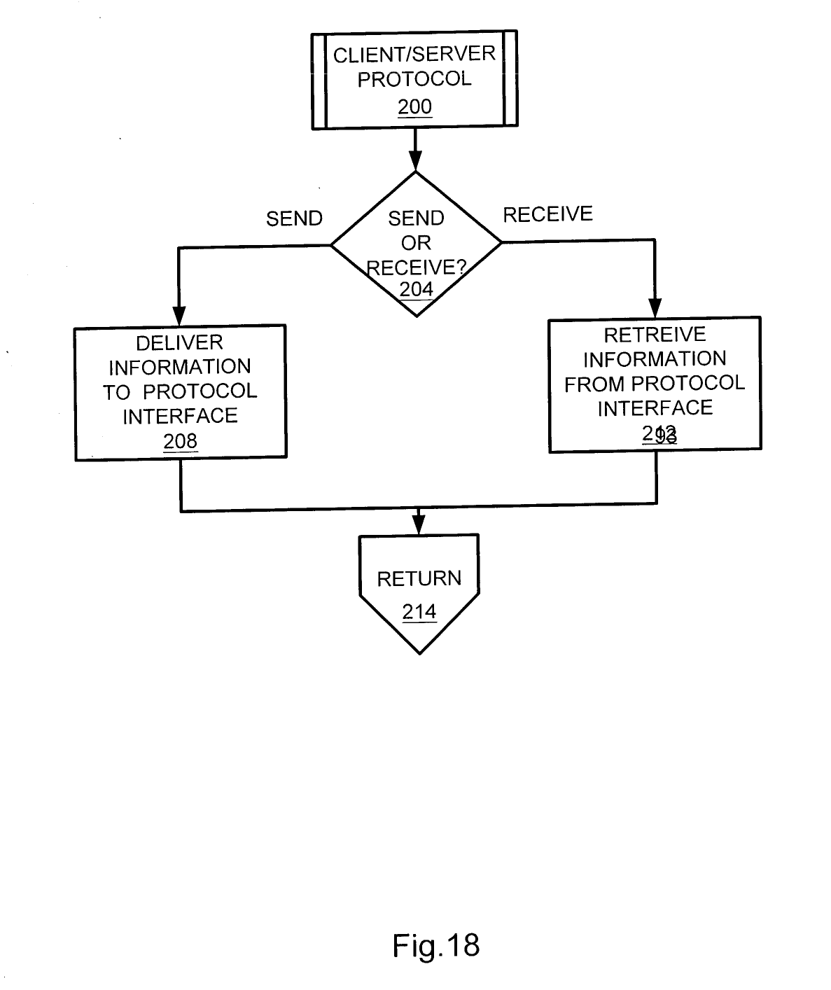

FIG. 18: Client/Server Protocol

FIG. 18 illustrates the main software logic flow of a preferred embodiment of the client/server protocol software. The protocol provides a callable software protocol handler subroutine 200 for use by client and server applications software. The functions provided by 200 depend on whether information is to be sent or received from the protocol interface and is decided by step 204. Step 208 of the function will format and deliver protocol messages that are to be sent from the calling application to the protocol interface, for transmission to a peer application, prior to returning to the application via return path 214. Step 212 retrieves received protocol messages sent from remote peer applications and delivers them to the calling application prior to returning the application via return path 214. Those of ordinary skill in the art will recognize that many commercial as well as proprietary protocols may serve this purpose. For example commercial implementations of popular TCP/IP and FTP protocols are examples. In a preferred embodiment of the present patent, the client/server protocol is an application level protocol, which operates at the top layer of the protocol hierarchy. Therefore the client/server protocol may be encapsulated within lower level protocols for transport across a wide variety of network protocols and network topologies.

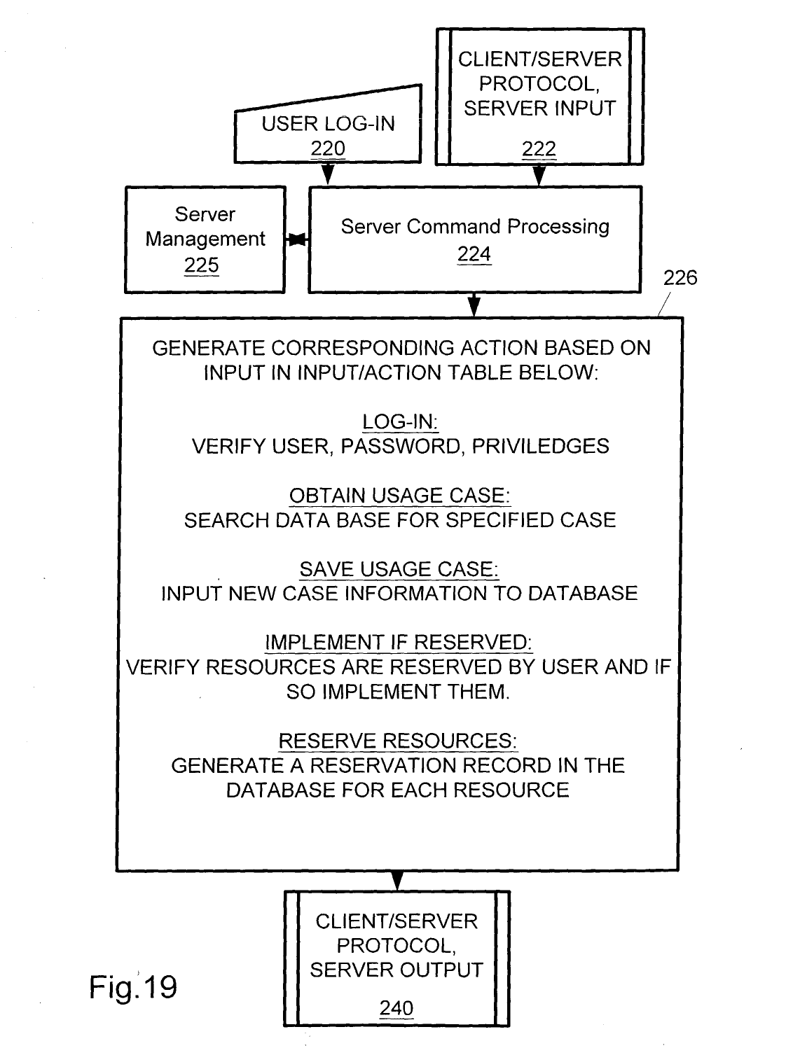

FIGS. 19 through 35: Software Operation of the Server Application

FIG. 19 illustrates the main software logic flow of an embodiment of server application software. According to the preferred embodiment, the server software is controlled either by manual input 220 or through messages delivered via the client/server protocol commands 222. The server may include a plurality of server command processing functions 224. A TCL command processing function 224 allows remote programs that are implemented in the TCL language to use the server functions including, but are not limited to those functions listed in box 226. Of course, a wide variety of equipment or computer control languages and be readily used in the present invention. Examples are languages such as Procomm, C, C++, Fortran, Pascal, and many others that are known to one of ordinary skill in the art. A client command processing function 224 allows remote clients that are implemented according to this embodiment to use the server functions, including, but are not limited to those functions listed in box 226. A graphical server user interface server command processor 224 allows server users 220 to directly control the server, according the functions listed in box 226, and also provides server management functions 225.

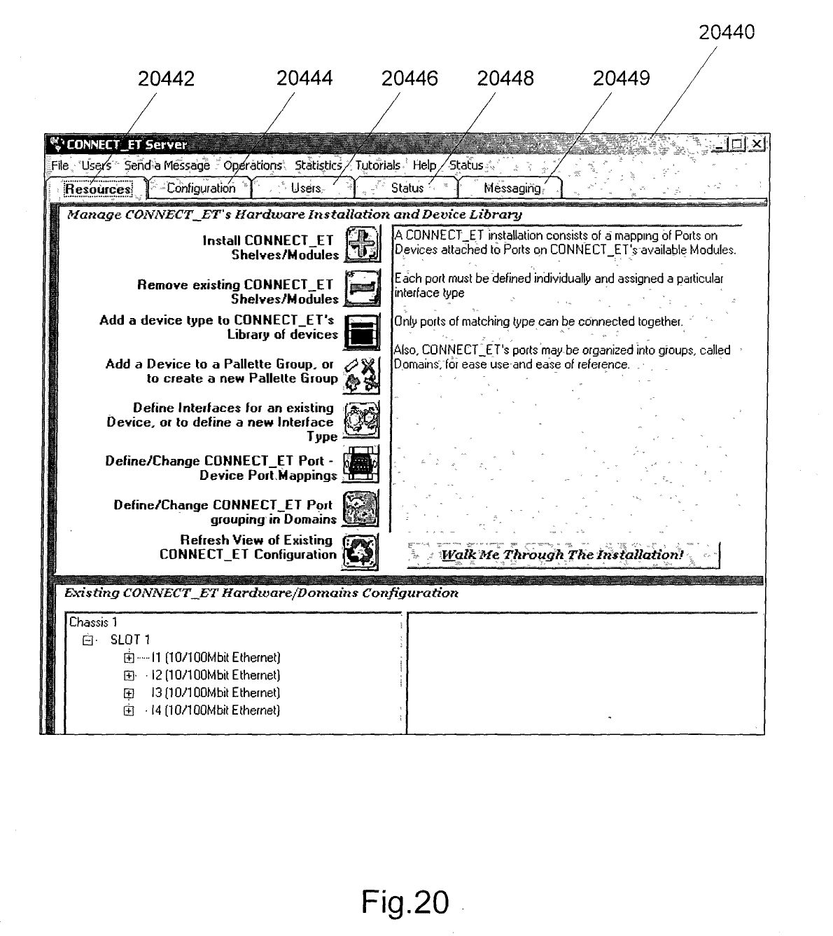

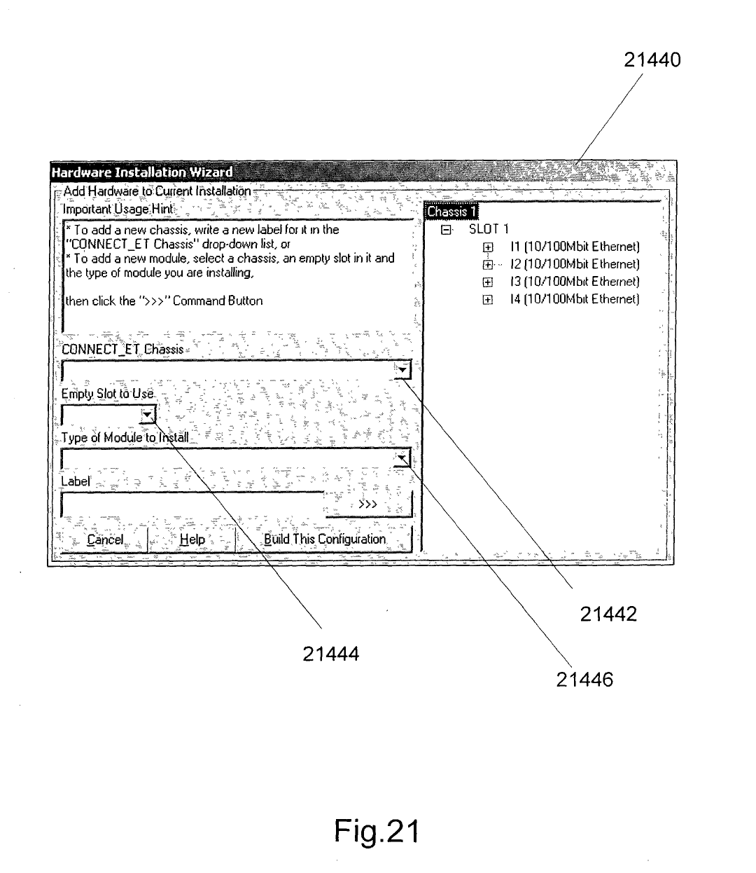

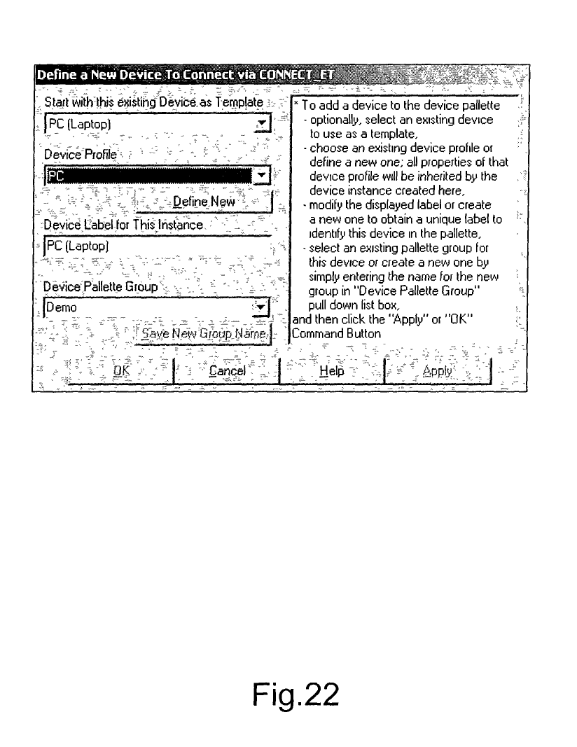

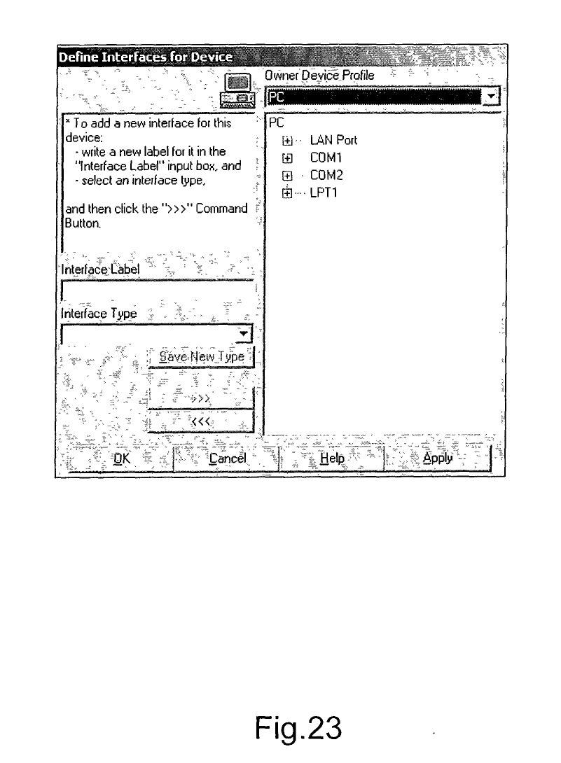

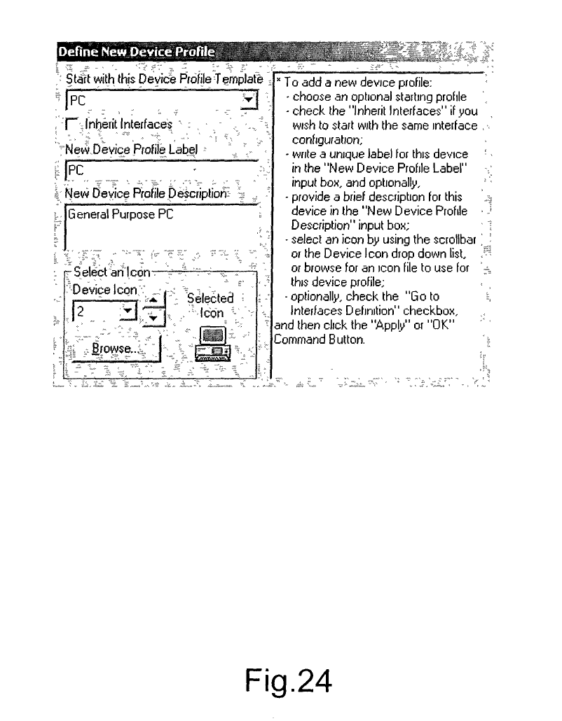

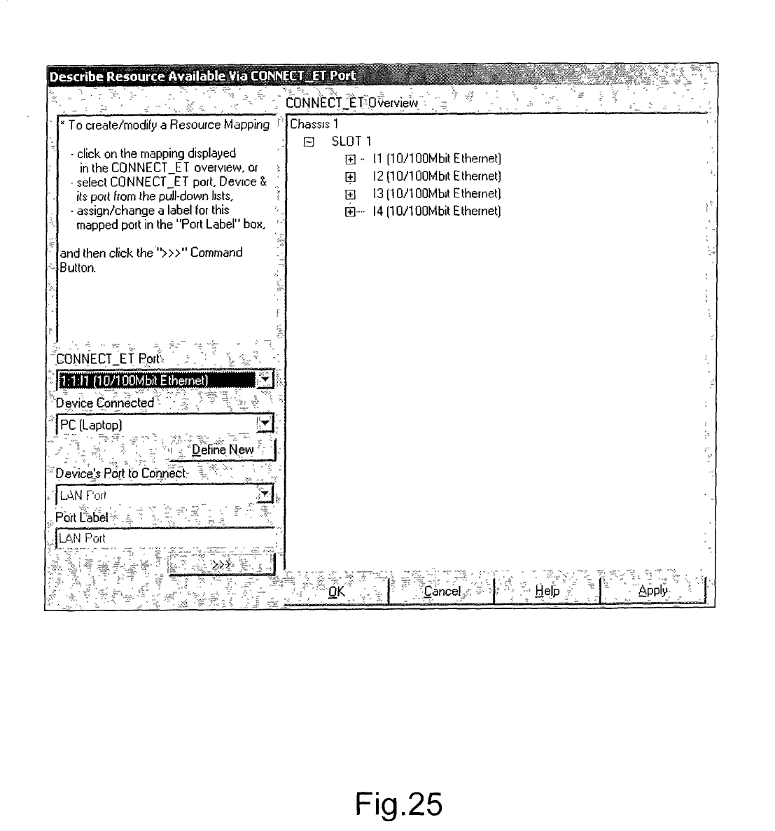

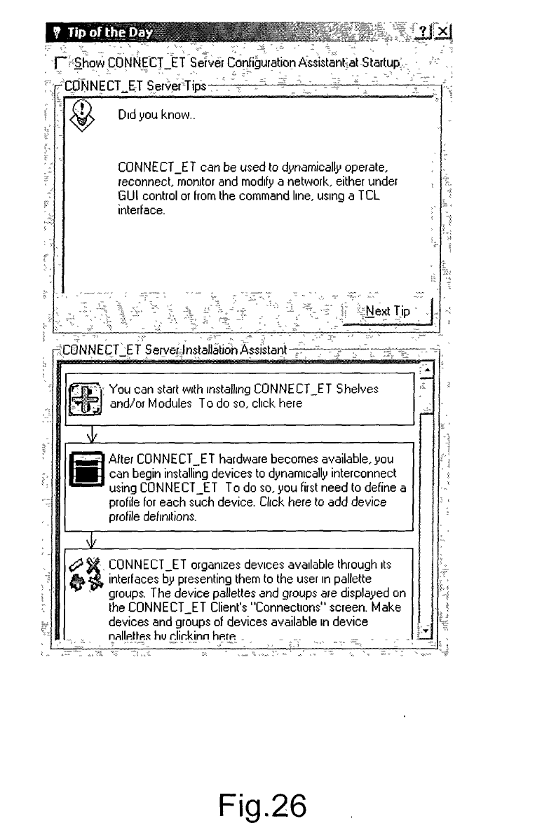

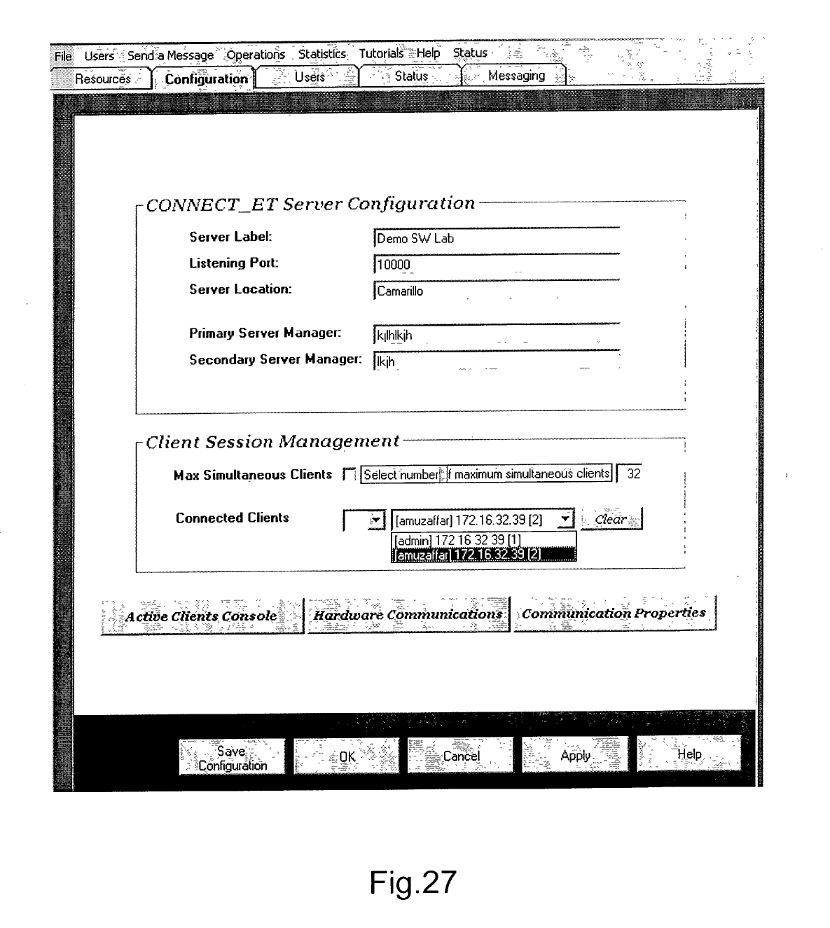

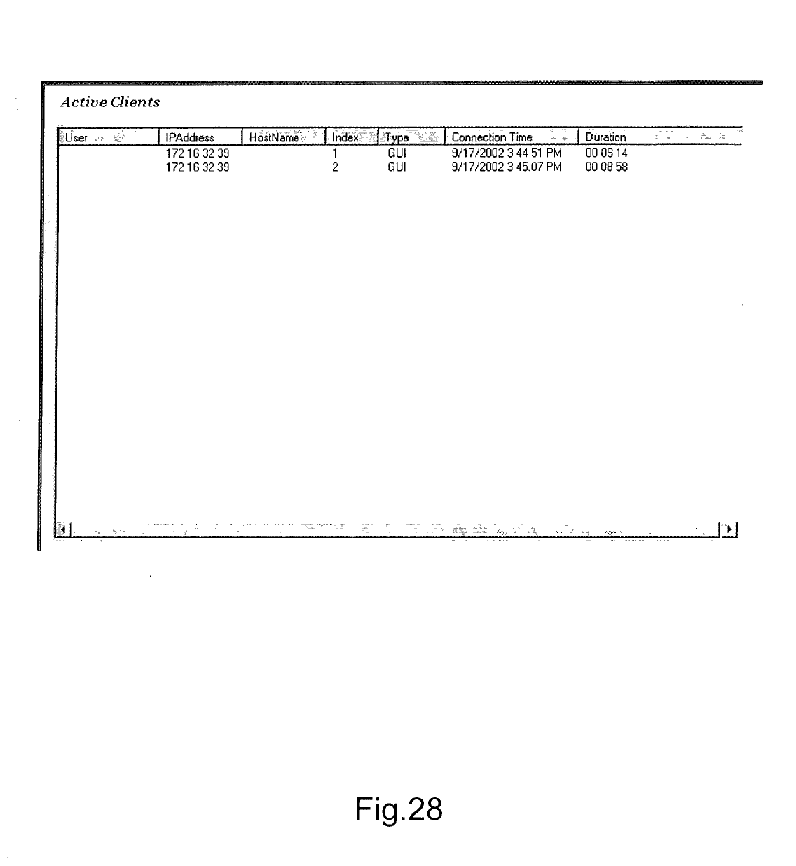

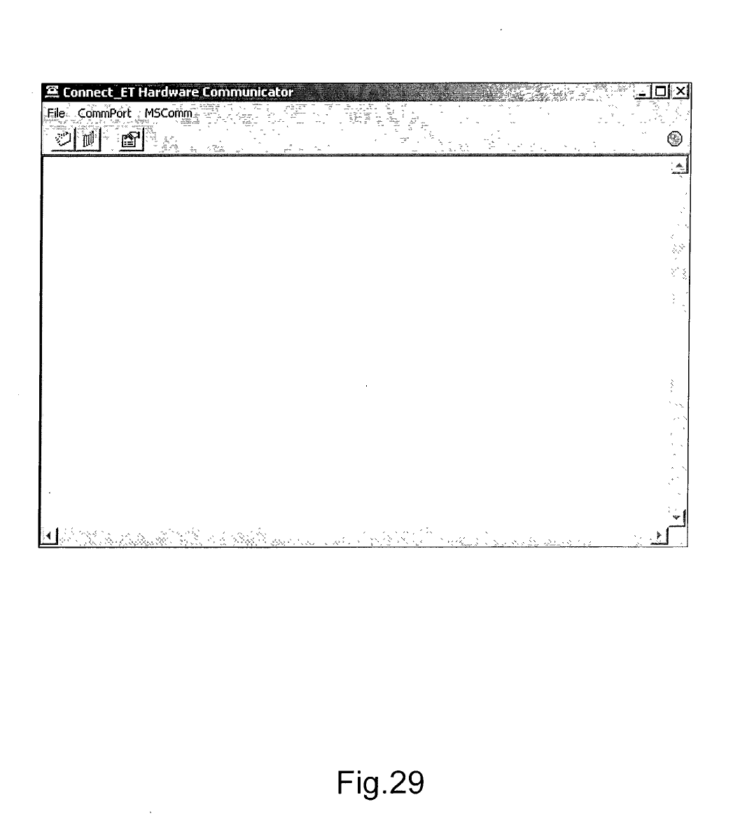

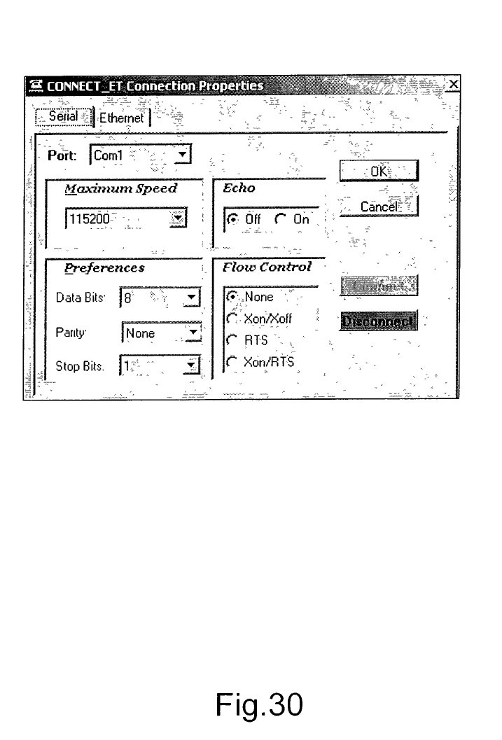

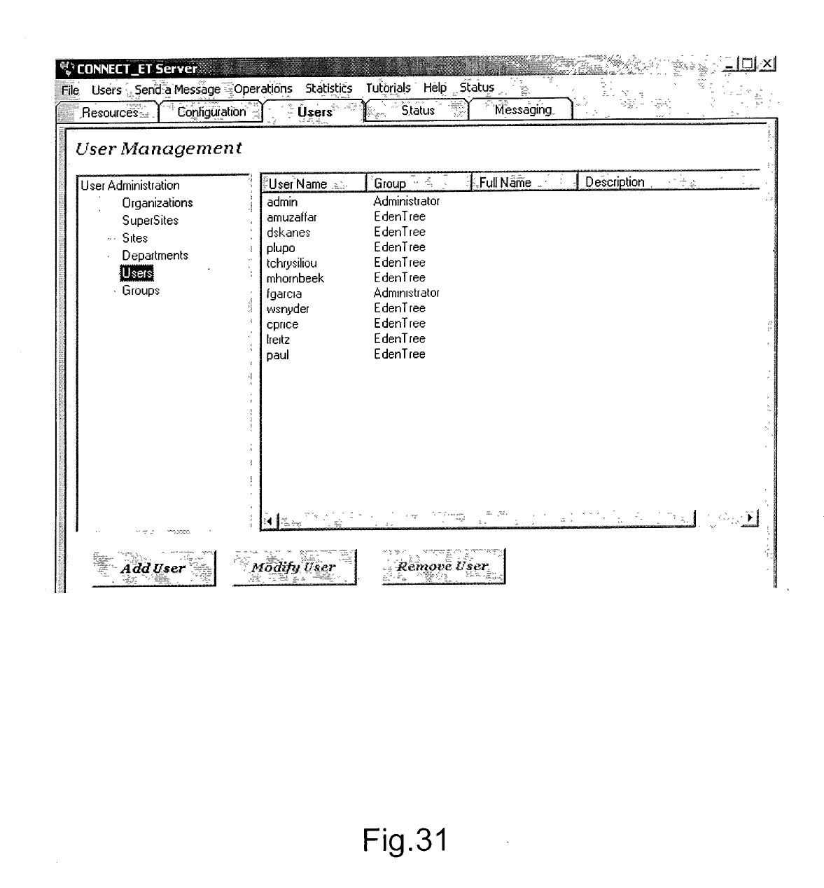

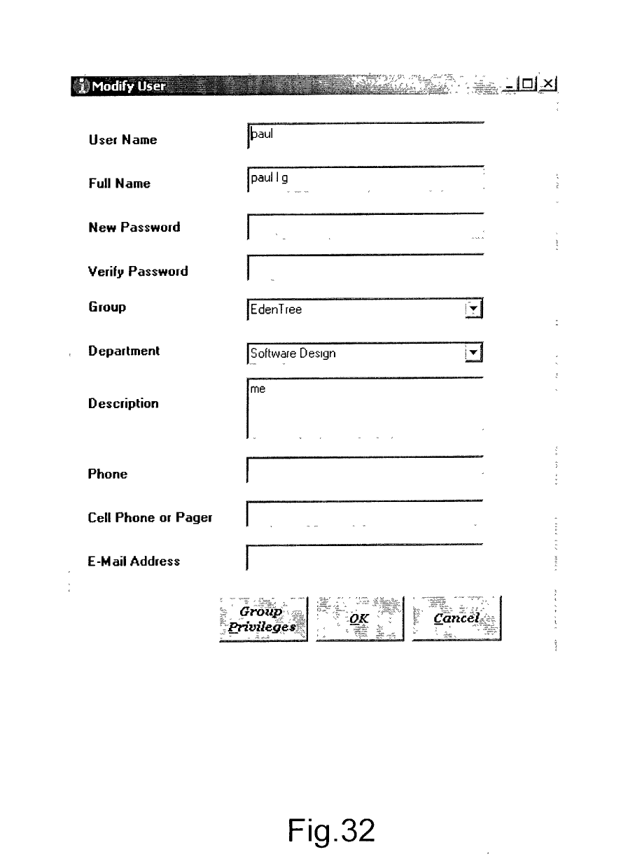

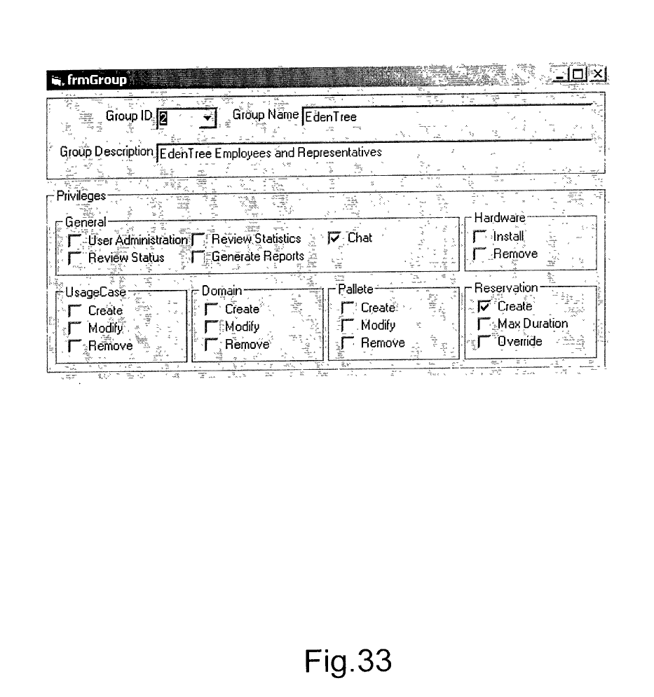

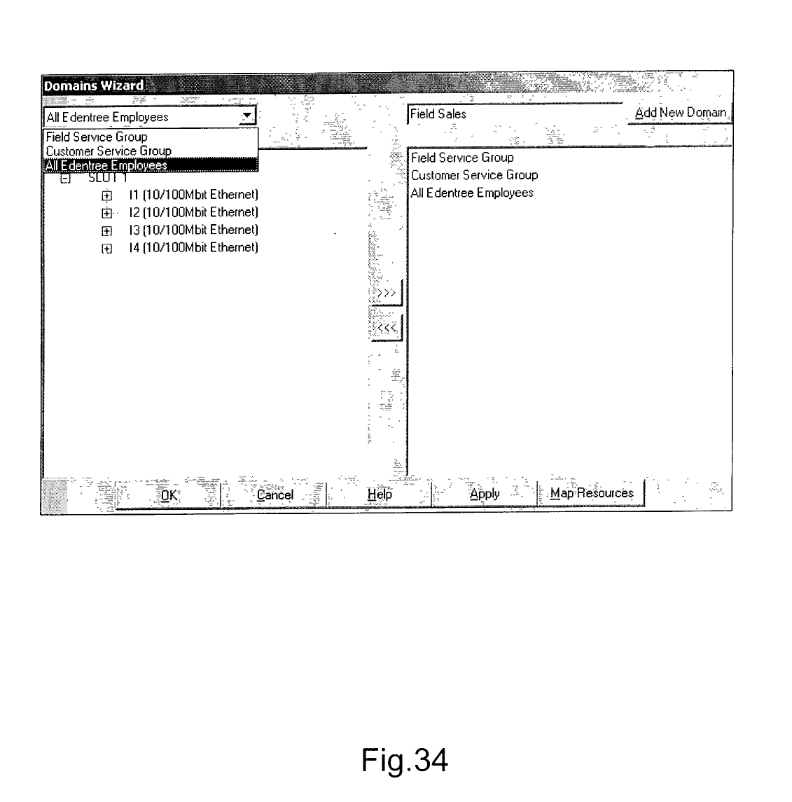

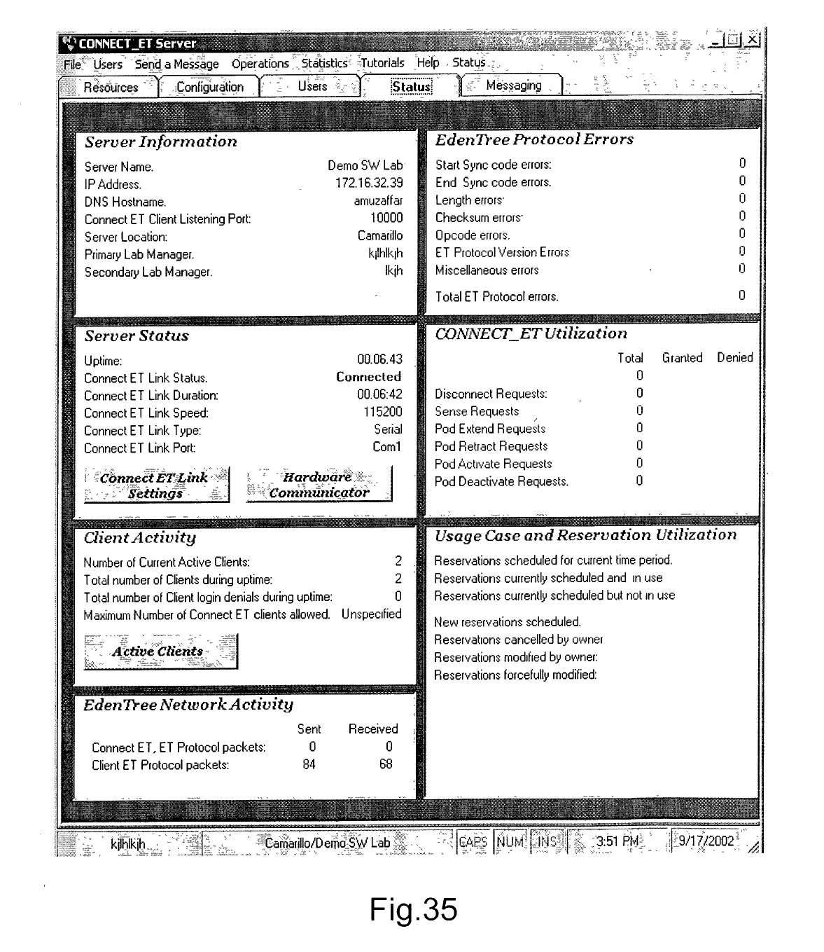

FIG. 20 illustrates the main graphical screen layout 20440 for this embodiment of the server management functions, which includes features to manage resources 20442, configurations 20444, users 20446, status information 20448 and messaging information 20440. FIG. 21 shows an embodiment of the hardware installation wizard graphical user interface; each time a new hardware device is installed into the inventive system, the Hardware Installation Wizard 21440 is used to define the new hardware to be connected. Users choose from predefined devices, chassis, slots and modules by way of drop-down list selectors 21442, 21444, and 21446, or create new ones by simply typing in the new names. New devices are defined and added to the device pallet using the dialog box shown in FIG. 22. Interfaces to devices are defined and added to the device using the dialog box shown in FIG. 23. Device profiles are defined and added to the server using the dialog box shown in FIG. 24. Resource mappings are defined and added to the server using dialog box FIG. 25. Server configuration tasks are facilitated by the dialog box shown in FIG. 26. Server Configuration parameters are set using dialog box shown in FIG. 27. Active clients of the server are listed using the report illustrated by FIG. 28. Hardware communication is displayed using the report illustrated in FIG. 29. Protocol connection properties are set using the dialog box illustrated by FIG. 30. User management is performed with the dialog box illustrated in FIG. 31. User names and user specific parameters are defined according to the dialogue illustrated in FIG. 32. User group parameters are defined according to the dialogue box illustrated in FIG. 33. User domain parameters are defined according to the dialogue box illustrated in FIG. 34. Status information is reported according to the pop-up report illustrated in FIG. 35.

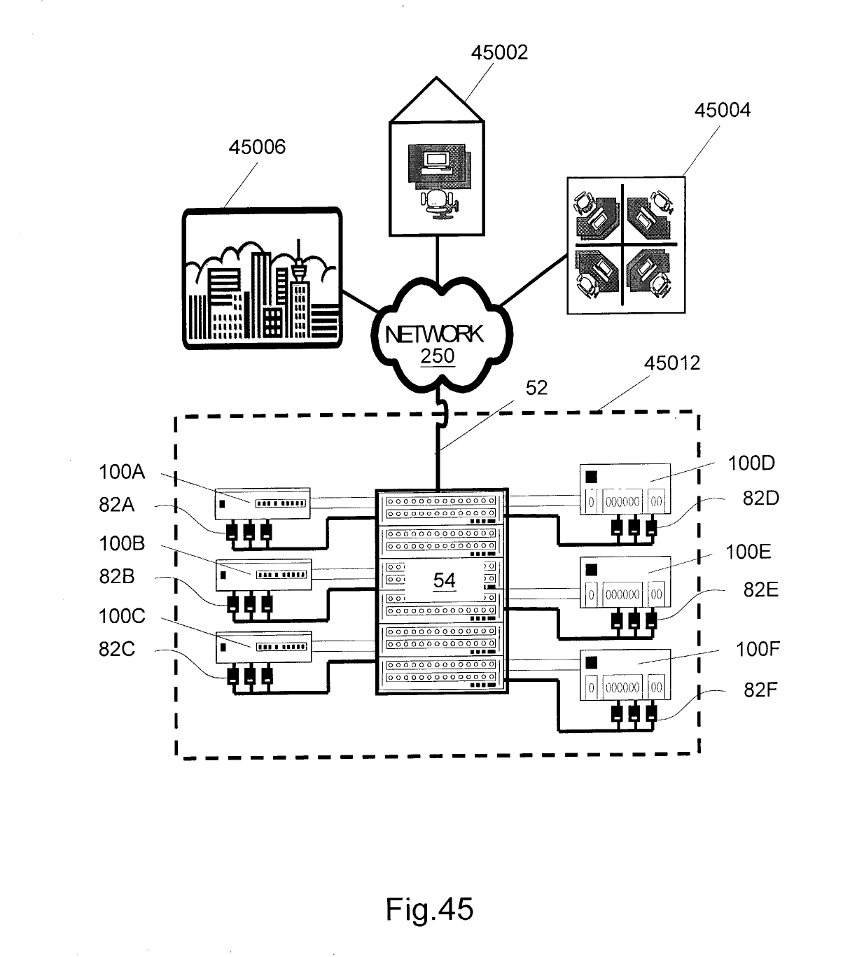

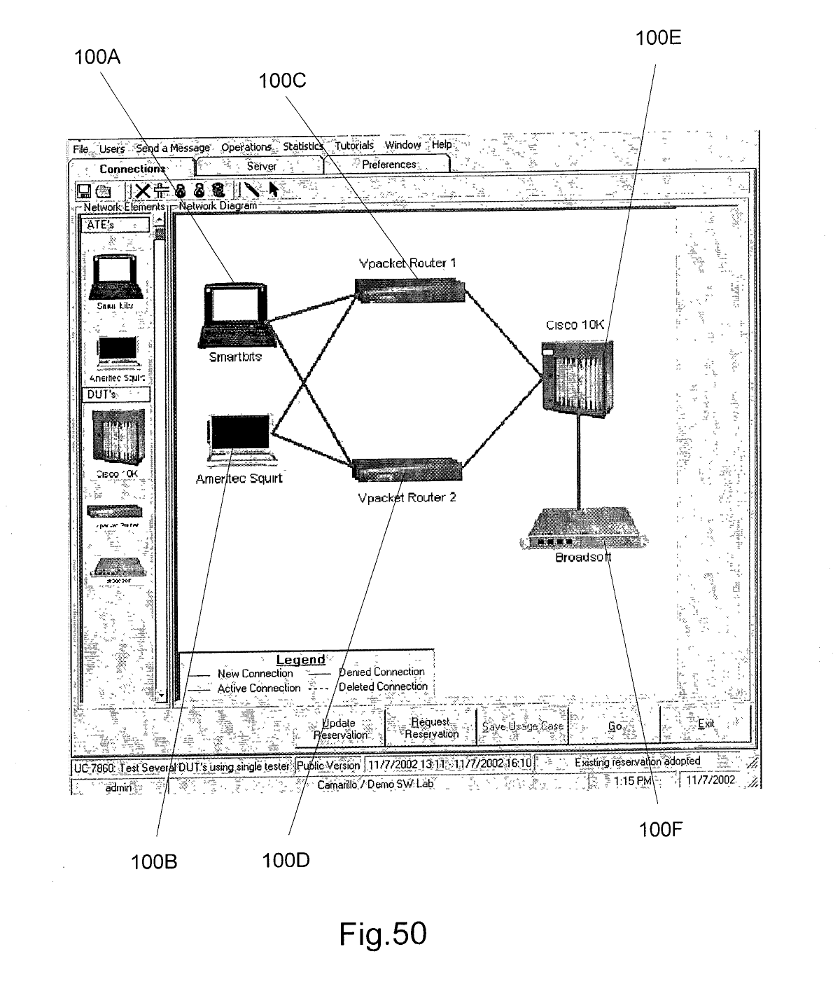

FIGS. 45 and 50: Remote laboratory applications.

FIG. 45 illustrates a schematic block diagram of a remote laboratory application of the present invention. According to this example, the invention 54 is installed in a laboratory 45012. A plurality of equipment of various types, illustrated by 100A through 100F, is connected to the invention 54 and a plurality of action modules illustrated by 82A through 82F is also connected to the equipment units and the invention 54. Remote client users located away from the laboratory in offices illustrated by 45004, homes or hotel rooms illustrated by 45002, and remote cities or countries illustrated by 45006, are provided remote access to the equipment via network connection 52, and network 250 such as the Internet. For example, assume the equipment 100A is an Ameritec® Squirt bulk telephone call load box, equipment 100B is a Spirent Communications Smartbits® Ethernet load box, the equipment 100C and 100D are Vpacket® 6100 Voice-Data router integrated access devices, the equipment 100E is a Cisco® 10K router and the equipment 100F is a BroadSoft® Softswitch. The data and telephone connections of these equipment units are connected to the invention 54. Also the power sources led indicators and reset button hand controls of each equipment unit are connected to the action modules 82. The invention enables a plurality of clients at 45006, 45002 and 45004 with the ability to access, interconnect, and control these equipment units remotely through the client interface software, the client server protocol, the command and display modules, and the action modules provided by the invention 54. One client may wish to configure this equipment remotely to perform a test or experiment in which the voice and data performance characteristics of the Vpacket voice-data router are determined. To do so the client commands the invention 54 to interconnect the Smartbits 100B and the Ameritec 100A to the line side of the Vpacket units 100C and 100D. The client also commands the invention 54 to connect the Cisco 100E, as well as the BroadSoft 100F, to the network side of the Vpacket units 100C and 100D. Once these connections are reserved and activated by the invention 54, then the client has control of these devices, powers them on using the power action modules, resets the equipment, and monitors the led status lights using 82A through 82F and downloads software configurations from the client computer or other computers on the network that will provide software specific to the test configuration. With the software configurations and hardware interconnections implemented by the invention 54, the user commands the Ameritec 100A and Smartbits 100B to generate telephone and Ethernet data traffic through the Vpacket units 100C and 100D, the Cisco 100E and the Broadsoft 100F. FIG. 50 shows a view of the client connection graphical user interface of the present invention configured to carry out this remote laboratory application. The traffic console information is monitored remotely by the client and results are documented. Meanwhile other clients can be developing other usage cases and reserving the same equipment for use while the current client is using the equipment. It should be apparent that this example demonstrates how the invention enables a number of applications. Because the client interaction with the equipment 100 is carried out through the invention 54 all aspects of the experimental setup as well as the experimental results are automatically recordable. This greatly facilitates creation of reports documenting the experiment as well as allowing the experiment to be exactly replicated in the future by clients less skilled than the engineer or scientist who originates the experiment.

One application that this example illustrates is the ability of the invention to provide remote access for user clients in different locations. This saves time and travel costs for these users.

Another application that this example illustrates is the ability of the invention to provide an equipment switch. This allows equipment to be shared and this saves capital equipment money.

Yet another application that this example illustrates is the ability of the invention to provide telecommuting resources for users that prefer to work from home or remote offices. This allows equipment to be accessed without commuting to the lab, and this saves time.

Still another application that this example illustrates is the ability of the invention to provide multiple laboratories to be consolidated for groups of users that are not co-located. This allows equipment to be pooled and saves equipment costs and saves the cost of separate laboratory management personnel.

Still yet another application that this example illustrates is the ability of the invention to enable laboratories to operate as clean rooms, without benches or facilities for people in the laboratory. This allows the laboratory facility to be dedicated and optimized for equipment usage and eliminates the possibility for unsafe behavior or accidents in the laboratory. This saves facility costs and saves the cost of wasted time due to human errors and accidents.

Yet another application that this example illustrates is the ability of the invention to enable laboratory equipment management to be automated. This allows the laboratory equipment that is connected to the invention to be monitored to determine its utilization and keep maintenance records and automate fault detection and recovery mechanisms for the equipment. This helps laboratory management personnel to identify underutilized or over utilized equipment and thus enables well maintained equipment, efficient use of equipment, reduced equipment costs and saves the cost of wasted time due to equipment errors.

This example also illustrates is the ability of the invention to enable increased utilization of laboratory equipment. This allows the laboratory equipment that is connected to the invention to be shared 24 hours per day, 7 days per week, by a wide range of clients across an entire enterprise. The reservations capability coupled with remote access and the features of the invention makes it easy for a wide variety of clients to easily access, configure and use the equipment harmoniously without reservation clashing. This improved utilization of equipment improves the utility and value derived from each equipment unit, which saves money and decreases time to market for new product development.

Another application that this example illustrates is the ability of the invention to enable more efficient equipment usage by each client. The time to find the equipment, connect it and document the configuration and results is essentially automated. This can save a typical laboratory user up to 75% of the time it takes to perform the tests. This 75% productivity boost translates to major cost savings in operating expenses and also reduces time to market for development organizations. It also enables the clients to spend their time with the equipment more effectively, enabling a heightened focus on product quality.

Yet another application that this example illustrates is the ability of the invention to enable a time-share business model for pay-for-use laboratory businesses over the Internet and worldwide web. A business that implements a laboratory using the invention may offer laboratory testing services via the worldwide web. This can eliminate the need for small and large companies to buy or lease specialized laboratory equipment for specialized tests, and save them capital expense as well as operating expenses and also time-to-market costs.

Still another application that this example illustrates is the ability of the invention to enable new distance learning business models for pay-for-access classroom laboratory businesses over the Internet and worldwide web. A business that sells training course products for courses, which require access to laboratory equipment configurations, can use the invention to offer courses with hands-on access to equipment via the worldwide web. This eliminates the need for students to travel to the courses and enables 24 hours/7 days per week business opportunities for the business. It also enables continuous self-paced instruction for students anywhere over the web. It saves equipment and operating costs for the businesses and reduces tuition and expense costs for the students.

Another application that this example illustrates is the ability of the invention to enable sales demonstrations of product equipment over the Internet and worldwide web. A business that sells equipment products, which require customer demonstrations, can use the invention to deliver live demonstrations of their equipment via the worldwide web. This is essentially a “teleconference” version of equipment use and demonstration. This eliminates the need for customers to travel to the equipment to see a demonstration and enables 24 hours/7 days per week demonstration opportunities for the equipment. It also eliminates the need for sales staff to transport equipment to customers. It reduces the cost of demonstration equipment for a business and provides more of the sales force with instant access to the latest equipment and more types of equipment products. It avoids the problem of demonstration failure due to equipment damage resulting from transport of the equipment.

This example also illustrates is the ability of the invention to enable self-certification of product equipment over the Internet and worldwide web. A business that sells equipment certification services that require customer products to be tested according to standards can use the invention to connect samples of the customer equipment and provide the customer access to the certification test laboratory via the world-wide web. This eliminates the need for customers to travel with their product equipment to the certification laboratory and enables 24 hours/7 days per week certification opportunities for the certification business. Rather than suffering serious down time as critical engineers travel (and retravel) to the certification laboratories, all that is needed is to ship the equipment to the laboratory. Then the engineers can configure the tests (and retests) from their offices without wasting time. It also eliminates the need for sales staff to transport equipment to customers.

This example also illustrates is the ability of the invention to enable competitors to securely and confidentially validate the interoperability of their equipment products with common partner equipment products, in parallel over the internet and world-wide web. This eliminates the need for competitors to travel with their product equipment to the partner laboratory and enables secure and confidential 24 hours/7 days per week interoperability testing opportunities for the competitors business. It also eliminates the cost for test staff to travel to partner laboratories and improves time to market for all of the competitors.

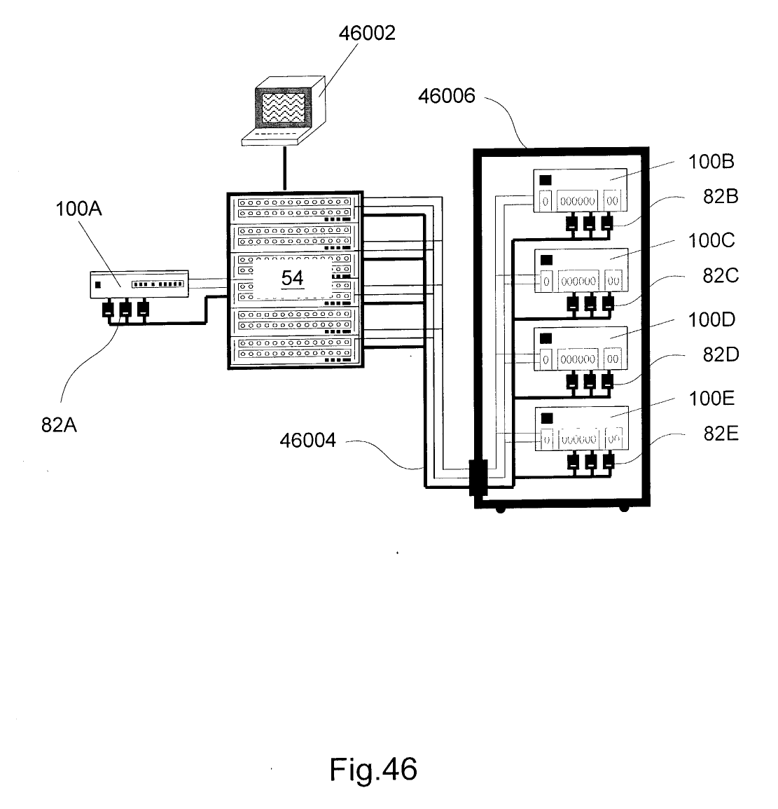

FIG. 46: Automated System Test Application

FIG. 46 illustrates a schematic block diagram of an automated system test application of the present invention. According to this example, the invention 54 and test equipment 100A are dedicated to testing equipment products in a controlled environment 46006 and connected via the cables 46004. A plurality of equipment products to be tested, which may be the same or various types, are illustrated by reference signs 100B through 100E and controlled by actions modules 82B through 82E, respectively. A computer program loaded into the test equipment 100A or the computer 46002 controls the configuration of equipment 100A through 100E, the operation of actions modules 82A through 82E, and executes the test instructions to be implemented by test equipment 100A and documents the results of the tests observed via test equipment 100A. Examples of specific equipment that may be employed in this example are a Dell® desktop computer 46002 running Microsoft Windows®, a Smartbits® tester 100A, and Cisco® routers 100B through 100E as products to be tested.

This example illustrates is the ability of the present invention to enable automated regression testing of the configuration of equipment products, including the hand controls, power states, light outputs and interconnection states of those products. This eliminates the need for human testers to perform these tests who otherwise would have to repeat them manually for every release of incremental product software or hardware releases. This automation saves time, and can be performed 24 hours/7 days with lower skilled operators than staff that would otherwise need to be trained and retained on the use of the equipment. It also improves product quality and reduces time-to-market because more exhaustive tests can be performed in a shorter time.

Still another application that this example illustrates is the ability of the present invention to enable automated box-level system testing for factories. This eliminates the need to hire and train human technicians to perform client product specific tests and eliminates the need to purchase separate test equipment setups for each box-test station because test equipment may be shared instead. This automation saves time, and can be performed 24 hours/7 days a week with lower skilled operators than staff that would otherwise need to be trained and retained on the use of the equipment. It also reduces capital equipment costs and improves the efficiency of the production line, improves product quality by affording better tests, and reduces time-to-market because more exhaustive tests can be performed in a shorter time. It also can eliminate several steps in the end-to-end manufacturing process because there is no need to package and ship partially configured products to a client factory for final test by client experts prior to shipment to the final customer.

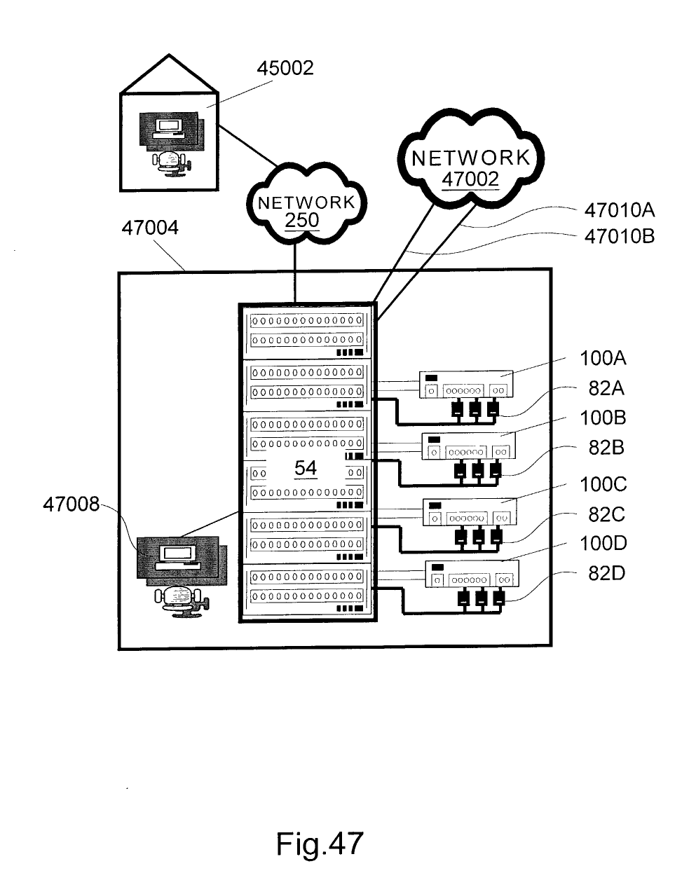

FIG. 47: Disaster Recovery Applications

FIG. 47 illustrates a schematic block diagram of the disaster recovery applications of the present invention. According to this example, the invention 54 is installed in an equipment closet 47004. A plurality of equipment units represented by 100A through 100D along with action modules 82A through 82D are connected to the invention. A computer 47008 is locally connected to the invention, a remote user 45002 is provided access to the equipment via dedicated network 250 and the equipment units are provided connections to switched network 47002 via interfaces 47010A and 47010B. Examples of specific equipment that may be employed in this example are a Dell® desktop computer 47008 running Microsoft Windows®, a Norstar® PBX 100A, Cisco® routers 100B, Smartbits® tester 100C and UPS power supply 100D.

This example illustrates the ability of the present invention to enable remote and automated disaster recovery functions for the information technology equipment room of an enterprise. An information technology specialist is able to remotely monitor the equipment in the equipment room from home, and is able to program the computer 47008 to perform routine surveillance tasks. In the event of a power brownout for example, the invention can detect changes in the power conditions and indicator lights through action modules 82A through 82D and can relay signals to the information technology specialist at 45002. The information technology specialist can immediately access all of the equipment from a remote location 45002, before the UPS shuts down and has the opportunity to invoke more efficient and effective recovery procedures than those available if travel to the equipment room were required and the state of the UPS or other equipment changed. This saves time and avoids costly operations downtime costs.

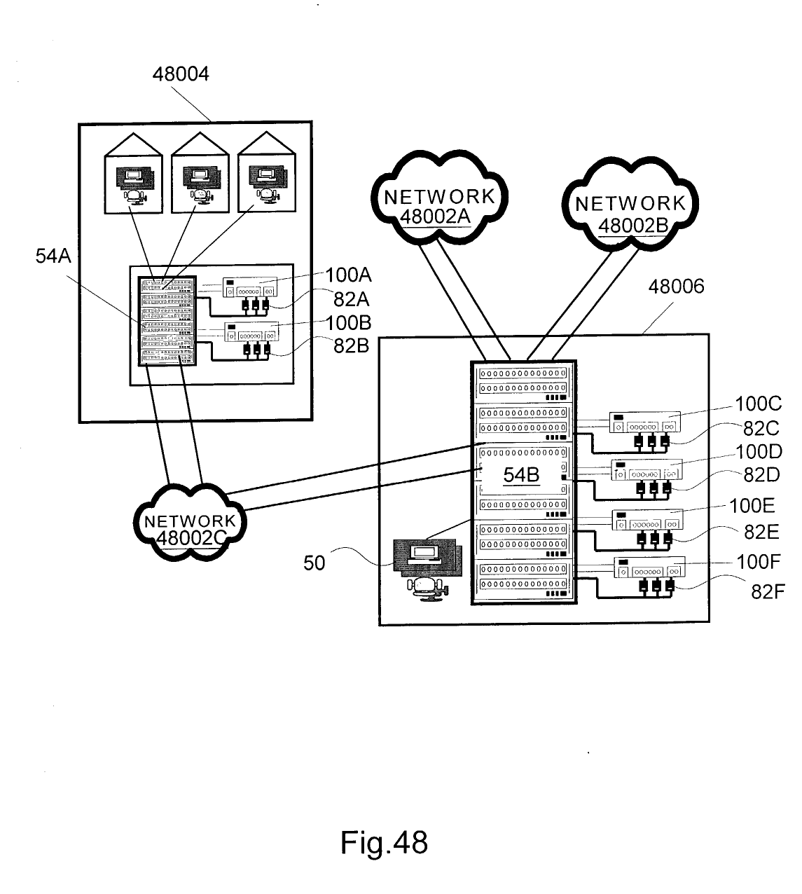

FIG. 48: Physical Layer Switched Network Applications.

FIG. 48 illustrates a schematic block diagram of physical layer switch network applications of the present invention. According to this example, the invention 54A is installed in an equipment closet of a multi-tenant unit 48004 connected to a matched pair of equipment units 100A and 100B and action modules 82A and 82B. A second invention 54B is installed in a central switching center 48006, connected to equipment units 100C through 100F, action modules 82C through 82F, client computer 50 and networks 48002A and 48002B. Examples of specific equipment that may be employed in this example are a pair of Vpacket® routers 100A and 10B, A Dell® computer 50 running Microsoft Windows®, a pair of Cisco® routers 100C and 100D, Smartbits® tester 100E and UPS power supply 100F.

This example illustrates the ability of the present invention to enable remote and automated disaster recovery functions for the router equipment 100A and 100B located at the multi-tenant unit 48004. Should the active router, say 100A, fail, the action modules detect the failure and automatically switchover to the stand-by router 100B. An information technology specialist located at 50 is able to monitor the failure activity and invoke recovery procedures remotely via the action modules and the invention 54A. This application reduces the down-time for the customers located at 48004 and helps the network operator to maintain its service level agreements with its subscribers, even in the case where portions of the network are equipped with non-redundant network elements.

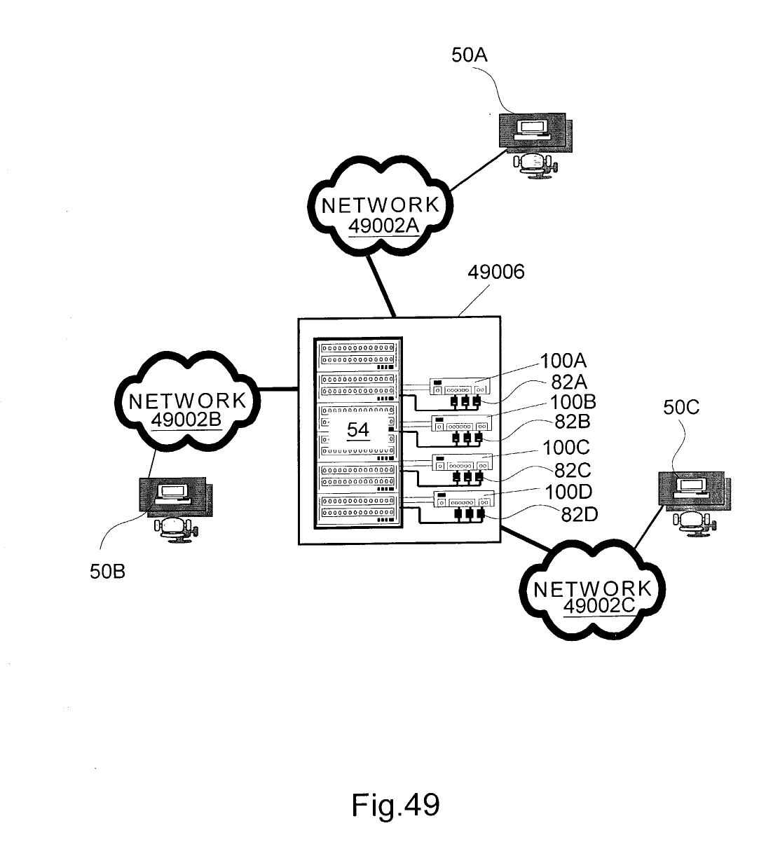

FIG. 49: Inter-Network Arbiter Applications.

FIG. 49 illustrates a schematic block diagram of the inter-network arbiter applications of the invention. According to this example, the invention 54 is installed in one or more central switching centers represented by 49006 that interconnects networks 49002A, 49002B and 49002C. The invention 54 enables shared access for a plurality of network operators illustrated at locations 50A, 50B and 50C to a plurality of network and test equipment represented by 100A through 100D. Examples of specific equipment that may be employed in this example are a pair of Cisco® routers 100A and 100B, Dell® computers 50A through 50B running Microsoft Windows®, a Smartbits® tester 100C and TTC Firebird® trunk test unit 100D.

This example illustrates the ability of the present invention to enable remote fault detection, test and repair functions for the network equipment 100A and 100B which are common network elements of the three interconnected subscriber carrying networks. When a fault is detected at this critical network juncture, the equipment 100A and 100B is monitored and controlled in a structure enabled by programming the invention 54 and by action modules 82A and 82B by all three network operators at 50A through 50C. Through the invention, the network can be remotely reconfigured by any of the operators 50A through 50C to attach test equipment 100C or 100D to a circuit and remotely run tests without having to send any technician or equipment to the site 49006. Once the test is completed and the information is analyzed the invention can be used to reconfigure and reboot the equipment and restore service, with minimal interruption to subscribers.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for enabling secure remote switching, robotic operation and monitoring of multi-vendor equipment comprising:
one or more server module computers with attached equipment interfacing resources for interfacing with and controlling multi-vendor equipment;
a server module software application capable of executing on each of the one or more server node computers to provide functions including access and control of the attached equipment interfacing resources;
one or more client computer simultaneously supported by the one or more server module computers; and
a client software application capable of executing on each of the client computers to provide users with an interface means to access the functions provided by the server module software application.

2. The system according to claim 1, wherein the client software application also provides an automated equipment control language means.

3. The system according to claim 2, wherein the automated equipment control language means is selected from the group consisting of C, TcI and Procomm.

4. The system according to claim 1, further comprising a client/server application level protocol for providing programmable levels of security and reliability for client software application data sent between server module computers and the client computers.

5. The system according to claim 1, wherein the interface means provided by the client software application is a graphical user interface.

6. The system according to claim 1, wherein a field-programmable gate array device is used.

7. The system according to claim 1, wherein the functions provided by the server module software application includes a plurality of distributed client/server software functions selected from the group consisting of user identification, security, privileges, resource installation, resource reservation, resource activation, statistical analysis of users and resources, user-to-user messaging, system debugging, usage case configuration data storage and retrieval, resource management and documentation of equipment configurations.

8. The system according to claim 1, further comprising a plurality of communication circuits types and protocol types for facilitating networked communication between the client software applications and the server module application.

9. The system according to claim 1, wherein the attached equipment interfacing resources comprise at least one action control module.

10. The system according to claim 9, wherein the action control module controls at least one device selected from the group consisting of a power module, a servo module, an action module and a light module.

11. The system according to claim 9, wherein the attached equipment interfacing resources further comprise at least one switch module.

12. The system according to claim 10, wherein the light module senses an intensity and/or a wavelength characteristic of at least one light on at least one piece of multi-vendor equipment.

13. The system according to claim 12, wherein the light module senses by means of a sensor selected from the group consisting of a photocell, a photodiode, a photoresistor, a phototransistor, a photomultiplier and a CCD device.

14. The system according to claim 10, wherein the servo module manipulates one or more hand controls of at least one piece of multi-vendor equipment.

15. The system according to claim 14, wherein the servo module uses electromechanical means selected from the group consisting of solenoids, servomotors, and stepper motors.

16. The system according to claim 10, wherein the power module controls and/or measures the voltage and current supplied to or originating from at least one piece of multi-vendor equipment.

17. The system according to claim 10, wherein the power module switches the voltage and current by means of a switch selected from the group consisting of a mechanical servo switch, a relay, a solenoid operated mechanical switch, a silicon controlled rectifier and a triac.

18. The system according to claim 11, wherein a plurality of switch modules interconnects a plurality of multi-wire communication circuit interfaces or fiber optical circuit interfaces.

19. The system according to claim 11, wherein the switch module comprises a switch selected from the group consisting of an optical switch using optical-to-electrical transceivers, an electrical switch using mechanical robotic means and an optical switch using mechanical robotic means to switch optical fiber cables.

20. The system according to claim 11, wherein the switch module comprises a low-cost mechanical-optical switch device for switching fiber optic communication circuits.

21. The system according to claim 11, wherein the switch module comprises a quad-4 relay matrix configuration.

22. The system according to claim 1, wherein the attached equipment interfacing resources further comprises at least one command and display module.

23. The system according to claim 22, wherein the command and display module connects the server module computer to a user-machine interface of at least one piece of multi-vendor equipment.

24. A method of implementing operation of test equipment by a remote user comprising the steps of:
providing at least one piece of test equipment to be operated;
attaching the inventive server module computer with attached equipment interfacing resources according to claim 1 to the at least one piece of test equipment;
providing a data network connecting inventive system and a remote computer system accessible to the remote user;
executing the client software application according to claim 1 on the remote computer system, whereby the remote user can use the remote computer and the network to access the server module computer and control the attached test equipment.

25. The method according to claim 24, wherein the test equipment is data switching equipment.

26. The method according to claim 25, wherein the data switching equipment is selected from the group consisting of an Ethernet load box, a router, a voice-data router, a telephone switch and a bulk telephone load box.

27. The method according to claim 26, wherein the data switching equipment is attached to a plurality of separate data transmission networks and the remote user is able to detect and repair faults and arbitrate exchanges between the separate data transmission networks.

28. A method of providing classroom instruction requiring manipulation of laboratory equipment by students comprising the step of executing the method according to claim 24, wherein the test equipment is laboratory equipment and wherein each student is a remote user.

29. A method of providing pay-for-use access to test equipment comprising the step of executing the method according to claim 24 and further comprising the step of levying a charge.

30. The method according to claim 29, wherein the step of levying a charge takes place by means of the network.

31. The method according to claim 29, wherein the step of levying a charge takes place before the control of said attached equipment.

32. The method according to claim 29, wherein the step of levying a charge takes place after the control of said attached equipment.

33. A method of automating testing of equipment comprising the steps of:
providing at least one piece of equipment to be tested;
attaching the inventive server module computer with attached equipment interfacing resources according to claim 1 to the at least one piece of equipment to be tested;
providing a test equipment interfaced to the at least one piece of equipment to be tested by means of the inventive server module computer;
executing the client software application according to claim 1 on a client computer system in communication with the inventive server module computer, whereby the client computer accesses the server module computer to control test equipment and the attached equipment to be tested to test said equipment.

34. The method according to claim 33, wherein the client computer communicates with the server module computer by means of a network.

35. The method according to claim 33, wherein the client computer is controlled by a recorded program without intervention of human testers.
